(19) United States
(12) Patent Application Publication
(10) Pub. No.: US 2025/0360787 A1
(43) Pub. Date: Nov. 27, 2025

(54) TWO-SPEED DISCONNECTING AWD SYSTEMS WITH PINION COUPLER

(71) Applicant: LINAMAR CORPORATION, Guelph (CA)

(72) Inventors: Todd Ekonen, Brighton, MI (US); Mitchell Holland, Royal Oak, MI (US); Evan Swinger, Farmington Hills, MI (US); Kyle Milliman, Farmington Hills, MI (US); Keegan Harrington, Stillwater, MN (US); Jayson Allison, Brighton, MI (US)

(21) Appl. No.: 18/873,699

(22) PCT Filed: Jul. 10, 2023
(86) PCT No.: PCT/US2023/027294

§ 371 Date: Dec. 10, 2024

Related U.S. Application Data
(60) Provisional application No. 63/359,217, filed on Jul. 8, 2022.

(51) Int. Cl. B60K 17/344; B60K 17/08; B60K 17/16; B60K 23/08; F16H 37/08; F16H 63/32

(52) U.S. Cl. CPC B60K 17/344; B60K 17/08; B60K 17/165; B60K 23/08; F16H 37/082; F16H 63/32; B60K 2023/0891; F16H 2200/0017; F16H 2200/0034; F16H 2200/2005; F16H 2200/2094

(57) ABSTRACT

A power takeoff unit (PTU) for an all-wheel drive vehicle includes an input shaft configured to receive power, a main shaft, and a takeoff shift collar axially slidable between an engaged position connecting the input shaft to the main shaft and a disengaged position disconnecting the main shaft from the input shaft. Power received by the input shaft is transferred through the takeoff shift collar to the main shaft, through a main ring gear, a hypoid pinion gear, and through a pinion shaft when the takeoff shift collar is in the engaged position and wherein the main shaft is decoupled from the input shaft when the takeoff shift collar is in the disengaged position.

### CROSS-REFERENCE TO RELATED APPLICATIONS

This application claims priority to U.S. Provisional Application 63/359,217, filed on Jul. 8, 2022, the disclosure of which is hereby incorporated by reference in its entirety.

### FIELD AND BACKGROUND OF THE INVENTION

The present invention relates to a disconnect assembly for an all-wheel-drive (AWD) vehicle. More particularly, the invention relates to a power takeoff unit (PTU) and a rear drive module (RDM) for an all-wheel-drive (AWD) vehicle.

### DESCRIPTION OF RELATED ART

Automotive all-wheel drive (AWD) vehicles may be primarily driven by a front axle powered by the vehicle engine through a gear box. The AWD vehicles may include an all-wheel drive system (AWD system) which includes a power takeoff unit (PTU) and a rear drive module (RDM). Power may be transferred to a rear axle by the power takeoff unit (PTU), a drive axle, and the rear drive module (RDM). It is commonly known for the PTU to selectively transfer power to the RDM through a gear set within the PTU. In addition, it is commonly known for the PTU to include an optional low range mode where the PTU is able to shift into a low gear range.

The RDM converts the rotational power from the drive axle to left and right output shafts to drive each of the left and right rear wheels of the vehicle. The RDM transfers power received from the drive axle through a clutch drum, through a pinion gear, a ring gear, and through a rear differential. The output shafts are driven by side gears in the rear differential which is driven by rotation of the ring gear. It is commonly known for vehicles to include a disconnect assembly engaged between the ring gear and the differential pinion gears to connect and disconnect the ring gear from the differential pinion gears. It is commonly known for the disconnect assembly to be actuatable by an actuator assembly, such as a hydraulic or electrically actuated clutch, a solenoid, and the like.

It is commonly known for vehicles to include locking differentials to prevent relative rotation of one driven wheel with respect to another driven wheel. This is usually accomplished by locking one differential side gear to a differential housing, thereby preventing rotation of the side gear with respect to the differential housing. It is also known to provide a hydraulically or electrically actuated clutch for locking and unlocking the side gear of the rear differential or one of the output shafts relative to the differential housing. In addition, it is commonly known for the RDM to include an optional low range mode where the RDM is able to shift into a low gear range.

It is desirable to provide an AWD system that is able to decouple the PTU and the RDM and stop rotation of certain components within the AWD system. It is also desirable to disconnect an input shaft to the PTU from the gear set to prevent power being transferred from the input shaft to the RDM. In addition, it is desirable for the PTU to include a single actuator to selectively transfer power to the RDM and to selectively shift into an optional low range gear.

In addition, it is also desirable to disconnect the RDM at the clutch drum to prevent power from being transferred between the clutch drum and the drive axle. Further, it is desirable to provide a disconnect assembly operated by a single actuator that is configured to lock/unlock the locking differential as well as to selectively shift into an optional low range gear.

### SUMMARY OF THE INVENTION

According to one embodiment, there is provided a power takeoff unit for a vehicle. The power takeoff unit includes an input shaft configured to receive power provided to the power takeoff unit, a main shaft, and a main ring gear non-rotatably coupled to the main shaft and which rotates in response to rotation of the main shaft. The power takeoff unit also includes a hypoid pinion gear meshingly engaged with the main ring gear and a pinion shaft non-rotatably coupled to the hypoid pinion gear such that rotation of the main ring gear causes the hypoid pinion gear and the pinion shaft to rotate. In addition, the power takeoff unit includes a takeoff shift collar which is axially slidable between an engaged position connecting the input shaft to the main shaft and a disengaged position which disconnects the input shaft from the main shaft. Power received by the input shaft is transferred through the takeoff shift collar to the main shaft, through the main ring gear, the hypoid pinion gear, and to the pinion shaft when the takeoff shift collar is in the engaged position and wherein the main shaft is decoupled from the input shaft when the takeoff shift collar is in the disengaged position.

According to another embodiment, there is provided a rear drive module for a vehicle. The rear drive module includes an input hub configured to receive power, a clutch drum, a torque transfer coupling configured to selectively transfer power between the input hub and the clutch drum when the torque transfer coupling is in an engaged condition, wherein the input hub is decoupled from the clutch drum when the torque transfer coupling is in a disengaged condition. The rear drive module also includes a hypoid pinion shaft non-rotatably coupled to the clutch drum, a hypoid pinion gear non-rotatably coupled to the hypoid pinion shaft wherein the hypoid pinion gear and the clutch drum rotate together, and a main ring gear meshingly engaged with the hypoid pinion gear. The rear drive module also includes a differential comprising: a differential housing, a differential shaft non-rotatably coupled to the differential housing, opposing pinion gears rotatably connected together by a pinion shaft which is mechanically connected to the differential housing, opposing first and second side gears in meshing engagement with the pinion gears such that power can be transferred from the differential housing to the pinion gears and then to the first and second side gears. In addition, the rear drive module also includes a first output shaft non-rotatably coupled to the first side gear and a second output shaft non-rotatably coupled to the second side gear. The rear drive module also includes a planetary gear set comprising a sun gear non-rotatably coupled to a sun shaft which is non-rotatably coupled to the main ring gear, a planetary ring gear disposed radially outwardly of the sun gear, and a planetary carrier assembly comprising a planetary carrier rotatably supporting one or more planet gears thereon, wherein the planetary carrier is engaged with the planet gears for rotation together and the planet gears rotate between the sun gear and the planetary ring gear during rotation of the planetary carrier. The rear drive module also includes a shift collar splined to the differential shaft such that the shift collar rotates with the differential shaft while being axially slidable relative thereto, the shift collar is axially slidable between a 4HI position connecting the sun shaft to the differential shaft for transferring power received from the hypoid pinion gear to the differential housing and a 4LO position connecting the planetary carrier to the differential shaft for transferring power received from the planetary carrier to the differential housing, wherein the 4HI position is axially spaced apart from the 4LO position.

According to another embodiment, there is provided a rear drive module for a vehicle. The rear drive module includes an input hub configured to receive power, a clutch drum, and a torque transfer coupling configured to selectively transfer power between the input hub and the clutch drum when the torque transfer coupling is in an engaged condition, wherein the input hub is decoupled from the clutch drum when the torque transfer coupling is in a disengaged condition. The rear drive module also includes a hypoid pinion shaft non-rotatably coupled to the clutch drum, a hypoid pinion gear non-rotatably coupled to the hypoid pinion shaft wherein the hypoid pinion gear and the clutch drum rotate together, and a main ring gear meshingly engaged with the hypoid pinion gear. The rear drive module also includes a differential comprising: a differential housing configured to rotate in response to rotation of the main ring gear, a differential shaft non-rotatably coupled to the differential housing, opposing pinion gears rotatably connected together by a pinion shaft which is mechanically connected to the differential housing, and opposing first and second side gears in meshing engagement with the pinion gears such that power can be transferred from the differential housing to the pinion gears and then to the first and second side gears. The rear drive module also includes a first output shaft non-rotatably coupled to the first side gear and a second output shaft non-rotatably coupled to the second side gear. The torque transfer coupling also includes a friction clutch including a plurality of friction plates which are repositionable in an axial direction between the engaged condition coupling the clutch drum to the input hub and the disengaged condition decoupling the clutch drum from the input hub, a hydraulic piston configured to selectively apply pressure to the friction plates in the axial direction to reposition the friction plates to the engaged condition, and a return spring configured to bias the friction plates towards the disengaged condition. The return spring disengages the friction clutch decoupling the clutch drum from the input hub by axially separating the friction plates when pressure is removed from the friction plates.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a cross-sectional side view of a power takeoff unit (PTU) for an all-wheel drive system (AWD system) for use in a vehicle, according to a first embodiment of the present invention;

FIG. 2 is cross-sectional side view of a rear drive module (RDM) for the AWD system, according to the first embodiment of the present invention;

FIG. 3 is a partial cross-sectional side view of the PTU of FIG. 1, showing an all-wheel drive (AWD) takeoff shift collar in a disengaged position corresponding to a disengaged mode and showing a range shift collar in a high position corresponding to a high gear mode providing high gear range power to a front differential;

FIG. 4 is a partial cross-sectional side view of the PTU of FIG. 3, showing the takeoff shift collar in the disengaged position and showing the range shift collar in the high position;

FIG. 5 is a partial cross-sectional side view of the PTU in FIG. 4, showing the takeoff shift collar in an engaged position corresponding to an engaged mode and showing the range shift collar in the high position;

FIG. 6 is a partial cross-sectional side view of the PTU in FIG. 5, showing the takeoff shift collar in the engaged position and showing the range shift collar in a neutral position disengaged from a front differential;

FIGS. 7 is a partial cross-sectional side view of the PTU in FIG. 6, showing the takeoff shift collar in the engaged position and showing the range shift collar in a low position corresponding to a low gear mode;

FIG. 8 is a perspective view of a portion of the PTU of FIG. 1, showing a barrel cam actuator assembly, according to one embodiment of the present invention;

FIG. 9 is perspective view of the barrel cam actuator assembly of FIG. 8;

FIG. 10 is a partial cross-sectional side view of the RDM of FIG. 2, showing a shift collar in a 4HI position corresponding to a 4HI mode;

FIG. 11 is a partial cross-sectional side view of the RMD in FIG. 10, showing the shift collar in the 4HI position;

FIG. 12 is a partial cross-sectional side view of the RDM in FIG. 11, showing the shift collar in a neutral position;

FIG. 13 is a partial cross-sectional side view of the RDM in FIG. 12, showing the shift collar in a 4LO position corresponding to a 4LO mode;

FIG. 14 is a partial cross-sectional side view of the RDM in FIG. 13, showing the shift collar in a 4LO-Lock position corresponding to a 4LO-Lock mode;

FIG. 15 is a cross-section side view of a power takeoff unit (PTU) for an all-wheel drive system (AWD system) for use in a vehicle, showing a range shift collar in a high position corresponding to a high gear mode and showing a takeoff shift collar in an engaged position corresponding to an engaged mode, according to a second embodiment of the present invention;

FIG. 16 is a cross-sectional side view of the PTU of FIG. 15, showing the takeoff shift collar in the engaged position and showing the range shift collar in a neutral position corresponding to a neutral mode;

FIG. 17 is a cross-sectional side view of the PTU of FIG. 16, showing the takeoff shift collar in the engaged position and showing the range shift collar in a low position corresponding to a low gear mode;

FIG. 18 is a partial cross-sectional view of the PTU in FIG. 17, showing the takeoff shift collar in a disengaged position corresponding to a disengaged mode and showing the range shift collar in the high position;

FIG. 19 is a cross-sectional side view of a power takeoff unit (PTU) for an all-wheel drive system (AWD system) for use in a vehicle, showing a takeoff shift collar in an engaged position corresponding to an engaged mode, according to a third embodiment of the present invention;

FIG. 20 is an enlarged cross-sectional side view of a portion of the PTU of FIG. 19, showing the takeoff shift collar in the engaged position;

FIG. 21 is an enlarged cross-sectional side view of the PTU of FIG. 20, showing the takeoff shift collar in a disengaged position corresponding to a disengaged mode; and

FIG. 22 is a cross-sectional side view of a rear drive module (RDM) for the AWD system, according to a second embodiment of the present invention.

### DETAILED DESCRIPTION OF THE INVENTION

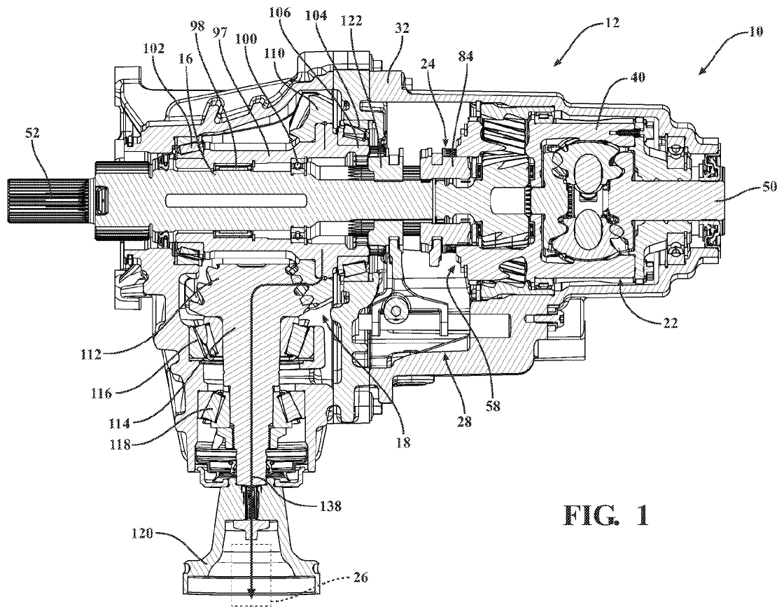

FIGS. 1-22 illustrate components of a disconnecting all-wheel drive (AWD) system 10 for use in an automotive vehicle according to embodiments described herein. Directional references employed or shown in the description, figures, or claims, such as top, bottom, upper, lower, upward, downward, lengthwise, widthwise, left, right, and the like, are relative terms employed for ease of description and are not intended to limit the scope of the invention in any respect. Referring to the Figures, like numerals indicate like or corresponding parts throughout the several views.

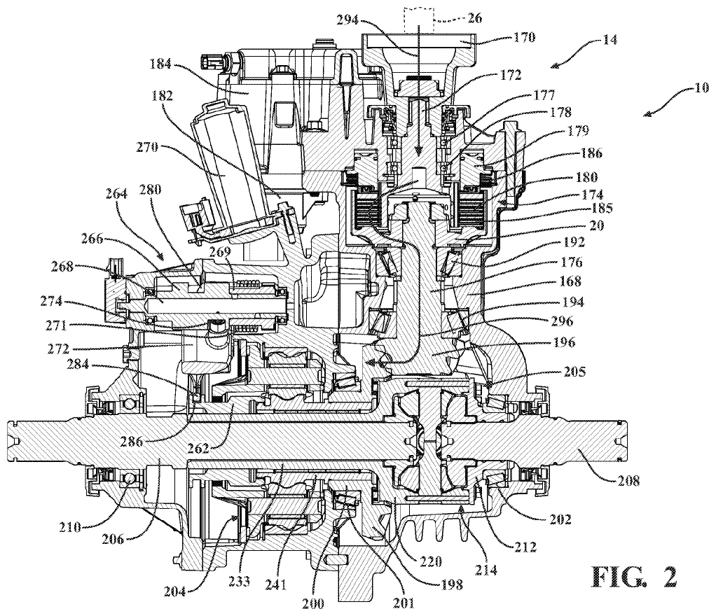

Referring to FIGS. 1 and 2, the vehicle AWD system 10 consists of a power takeoff unit (PTU) 12 and a rear drive module (RDM) 14, where the AWD system 10 is able to decouple the PTU 12 and the RDM 14 and stop rotation for improved fuel economy. The AWD system 10 disconnects an input shaft 16 from a PTU gear set 18 while the RDM 14 disconnects at a clutch drum 20. The AWD system 10 includes an optional low gear mode where both the PTU 12 and RDM 14 are able to shift into a low gear range.

Referring to FIG. 1, the PTU 12 consists of a front wheel power flow, delivering power from the input shaft 16 to a front differential 22 driving the front wheels (not shown). The PTU 12 includes a range shift mechanism 24 which allows the front wheel power flow to be shifted from a high gear range (i.e., normal), into the low gear range, or into neutral. The PTU 12 includes a second power flow through the PTU gear set 18 connected to a prop shaft 26 which sends power to the rear wheels (not shown). The second power flow is able to be selectively connected or disconnected from the input shaft 16, decoupling the torque flow to the rear wheels, utilizing an actuator assembly 28 that also actuates the range shift mechanism 24. It will be appreciated that the prop shaft 26 may be any type or combination of a propeller shaft, a drive shaft, a driveline, etc., as is known in the art for transferring power from the PTU 12 to the RDM 14.

The PTU 12 is provided on a vehicle (not shown). The PTU 12 might also be referenced as part of the vehicle axle as understood from the following description. The PTU 12 includes a stationary housing 32 defining an interior compartment in which the PTU gear set 18 and the front differential 22 are housed. In addition, the stationary housing 32 is stationarily supported on the vehicle. The PTU 12 is operatively connected to the drive shaft or the vehicle drive train and engine or motor, wherein the input shaft 16 is rotatably driven by the drivetrain.

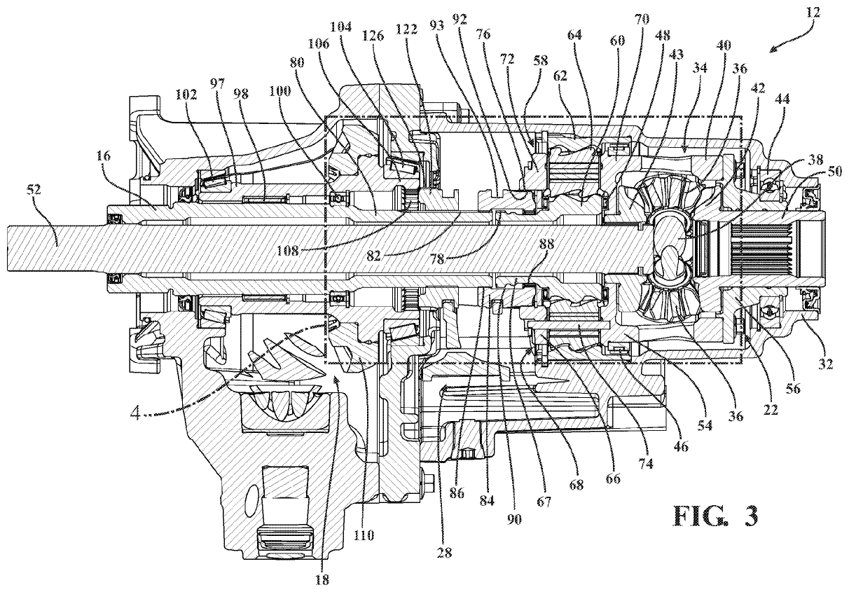

Depicted in FIG. 3, the front differential 22 includes a pinion gear assembly 34 rotatably supported within the stationary housing 32. The pinion gear assembly 34 includes opposing differential pinion gears 36, a pinion shaft 38, a differential housing 40, and opposing first and second side gears 42, 43. The pinion gears 36 are rotatably connected together by the pinion shaft 38 which is mechanically connected to the differential housing 40. In addition, the differential pinion gears 36 are in meshed engagement with the first and second side gears 42, 43 such that torque (i.e., power) can be transferred from the differential housing 40 to the differential pinion gears 36 and then to the first and second side gears 42, 43. The pinion shaft 38 rotatably supports the differential pinion gears 36 on the ends thereof and rotates with the differential pinion gears 36 as the differential pinion gears 36 travel about the first and second side gears 42, 43. The front differential 22 further includes a connector pin (not shown) fixedly coupling the pinion shaft 38 to the differential housing 40 so that the pinion gears 36, the pinion shaft 38, and the differential housing 40 of the front differential 22 all travel together about the same shaft axis as the side gears 42, 43. The differential housing 40 is supported radially and axially by bearings 44, 46 and can spin freely within the stationary housing 32.

The differential side gears 42, 43 are supported by the differential housing 40 and operate to drive torque to any combination of right and left output shafts 50, 52, (i.e., first and second output shafts) which may be any type of side shafts, half shafts, link shafts, etc. as is known in the art. The output shafts 50, 52 thereby rotate with and selectively drive vehicle wheels connected thereto. The differential housing 40 includes a housing end flange 54 and a cover end flange 56 which are open to allow the output shafts 50, 52 attached to the side gears 42, 43 to extend axially therefrom for driving of the wheels. Due to the connection of the output shafts 50, 52 and side gears 42, 43 to the wheels, the output shafts 50, 52 and side gears 42, 43 will rotate when the wheels rotate. The side gears 42, 43 are in meshed engagement with the pinion gears 36 and the input shaft 16 is engageable with the differential housing 40 such that torque can transfer from the input shaft 16 through the differential housing 40, the pinion gears 36, and then the side gears 42, 43 to thereby drive the output shafts 50, 52.

The PTU 12 also includes a planetary gear set 58 configured to selectively provide power in the high gear range and the low gear range to the front differential 22. The planetary gear set 58 defines alternate paths of torque transmission between the input shaft 16 and the front differential 22, which corresponds to the high gear range and the low gear range. The planetary gear set 58 includes a sun gear 60, a planetary ring gear 62, a set of planet gears 64, and a planetary carrier 66. The sun gear 60 is rotatably supported on the outer circumference of the left output shaft 52 and is integrally formed with a sun shaft 67. The planetary ring gear 62 is grounded to the stationary housing 32 and is concentric to the sun gear 60 in radially spaced, opposing relation. The set of planet gears 64 are meshed radially with the sun gear 60 and the planetary ring gear 62. The planet gears 64 are mounted to and supported by the planetary carrier 66 to form a planetary carrier assembly 68 that is rotatably supported on the output shafts 50, 52. The planetary carrier 66 has an outboard carrier section 70, an inboard carrier section 72, and circumferentially spaced support shafts 74 for rotatably supporting the planet gears 64. The outboard carrier section 70 is supported on the inboard end of the housing end flange 54, either integral therewith or as a separate component, such that rotation of the planetary carrier 66 rotates the differential housing 40.

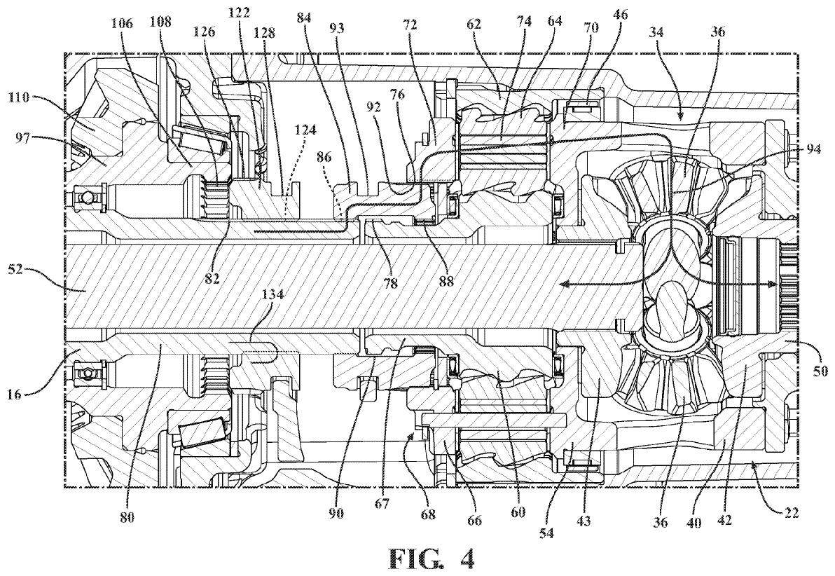

To selectively drive the planetary carrier 66, the inboard carrier section 72 includes drive formations preferably formed as drive teeth 76, shown in FIGS. 3 and 4. The carrier drive teeth 76 are formed about an inner circumference of the inboard carrier section 72 and face radially inwardly. However, it will be appreciated that the carrier drive teeth 76 might be formed with alternate configurations, such as facing radially outwardly, radially inwardly, or in an axial direction without varying the scope of the present invention.

To selectively drive the sun gear 60, the sun shaft 67 includes drive formations preferably formed as drive teeth 78. The sun drive teeth 78 are shown in FIG. 3 as formed about an outer diameter or surface of the sun shaft 67 and face radially outwardly. However, it will be appreciated that the sun drive teeth 78 might be formed with alternate configurations, such as facing radially outwardly, radially inwardly, or in an axial direction without varying the scope of the present invention.

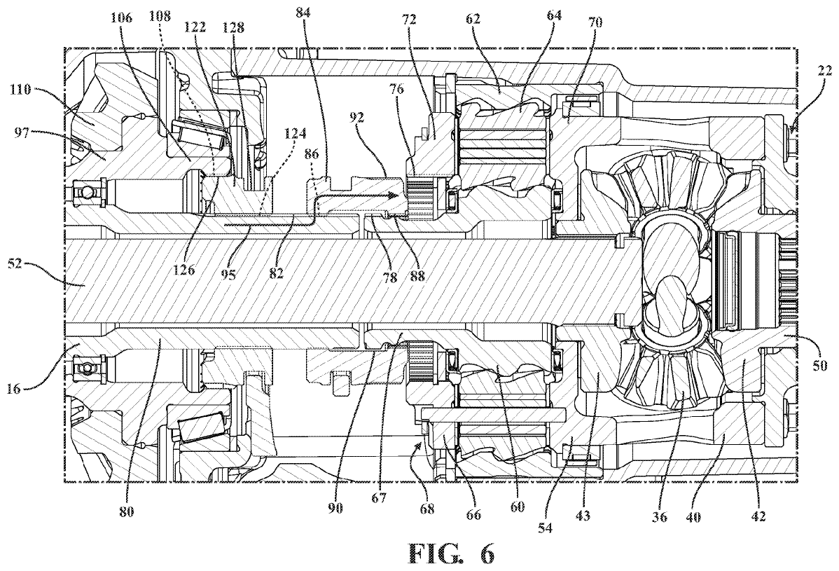

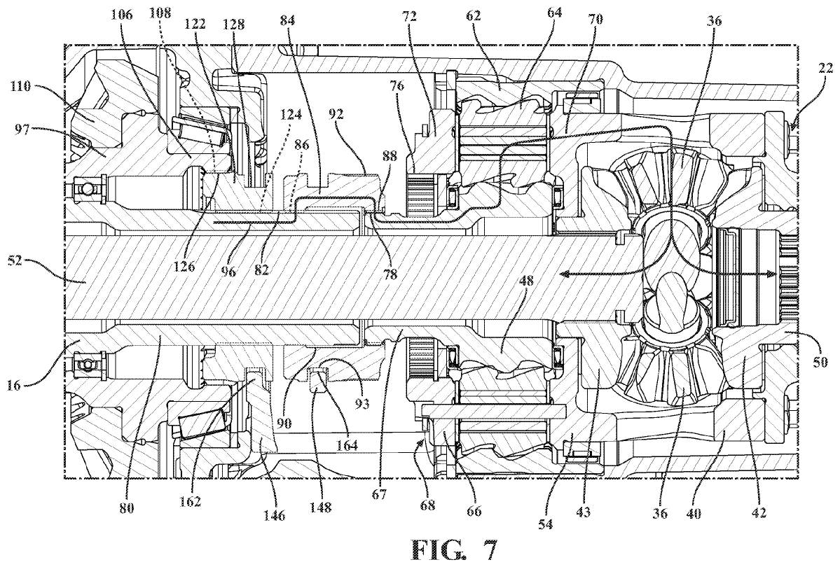

To switch the PTU 12 between the high gear range and the low gear range, the input shaft 16 also includes an end flange 80 which includes input drive teeth 82 formed on an outer circumference or surface of the end flange 80, which face radially outwardly and extend in an axial direction. However, it will be appreciated that the input drive teeth 82 might be formed with alternate configurations, such as facing radially outwardly, radially inwardly, or in an axial direction without varying the scope of the present invention. The PTU 12 also includes a range shift collar 84 which is splined to the input shaft 16 such that the range shift collar 84 rotates with the input shaft 16 while being axially slidable relative thereto. The range shift collar 84 is displaceable axially between three axially spaced positions corresponding to the high gear mode (high position, FIGS. 3-5), the low gear mode (low position, FIG. 7), and neutral (neutral position, FIG. 6). Referring to FIG. 1, the range shift collar 84 displaceable axially by a suitable actuator assembly 28 such as a hydraulic actuator that is electrically controlled by a vehicle controller, an electro-mechanical actuator, a solenoid, and the like.

Depicted in FIG. 4, the range shift collar 84 includes a main body that is formed with inner drive formations 86, which are formed as drive teeth formed on an inner circumference or surface and face radially inwardly. However, it will be appreciated that the carrier inner drive formations 86 might be formed with alternate configurations, such as facing radially outwardly, radially inwardly, or in an axial direction without varying the scope of the present invention. The inner drive formations 86 are meshingly engaged with the input drive teeth 82 on the end flange 80 of the input shaft 16 while allowing the range shift collar 84 to be displaceable axially along the input drive teeth 82 so as to remain engaged therewith in both of the high gear mode (high position) and the low gear mode (low position).

In addition, the range shift collar 84 includes low drive formations 88 which are shown in FIG. 4 as formed as drive teeth that face radially inwardly from the inner circumference or surface and are axially spaced apart from the inner drive formations 86. However, it will be appreciated that the low drive formations 88 might be formed with alternate configurations, such as facing radially outwardly, radially inwardly, or in an axial direction without varying the scope of the present invention. The low drive formations 88 are configured to meshingly engage with the sun drive teeth 78 on the sun shaft 67 when the range shift collar 84 is repositioned axially to transfer power through the sun gear 60 to provide the low gear range power to the front differential 22. The range shift collar 84 includes a recessed portion 90 spaced axially between the drive formations 86, 88 which provides radial clearance between the range shift collar 84 and the sun drive teeth 78 as the range shift collar 84 is transposed axially while the range shift collar 84 is disengaged from the sun shaft 67. The range shift collar 84 also includes high drive formations 92 which are shown in FIG. 4 as formed as drive teeth that face radially outwardly from an outer circumference or surface of the range shift collar 84. However, it will be appreciated that the high drive formations 92 might be formed with alternate configurations, such as facing radially outwardly, radially inwardly, or in an axial direction without varying the scope of the present invention. The high drive formations 92 are configured to meshingly engage with the carrier drive teeth 76 on the planetary carrier 66 when the range shift collar 84 is repositioned axially to transfer power through the planetary carrier 66 to provide the high gear range to the front differential 22.

In addition, the range shift collar 84 includes a range channel 93 extending circumferentially around an outer circumference or surface of the range shift collar 84. The range channel 93 is configured to be operatively coupled to the actuator assembly 28 allowing the range shift collar 84 to be repositioned axially between the high position (high gear mode), the low position (low gear mode), and the neutral position (neutral). It will be appreciated that the drive teeth 76, 78 and the drive formations 86, 88, 92 may formed like gear teeth but other configurations of drive formations might be provided without altering the scope of the present invention. Generally, the sun drive teeth 78 and the inner drive formations 86 are located at or about the same radial distance from the central axis extending through the input shaft 16, the left output shaft 52, and the right output shaft 50 although the distances may vary to vary torque transmission characteristics. Further, the carrier drive teeth 76 and the high drive formations 92 are located radially offset from the other drive teeth 78, 82 and the other drive formations 86. However, it will be appreciated that the radial position of the carrier drive teeth 76 and the high drive formations 92 might vary without altering the scope of the present invention.

The range shift collar 84 is shown in high position (high gear mode) in FIGS. 3-5. Referring to FIG. 4, the range shift collar 84 is positioned axially so that the high drive formations 92 are meshingly engaged with the carrier drive teeth 76 on the planetary carrier 66, providing the high gear range power to the front differential 22, as illustrated by arrow 94. The low drive formations 88 are spaced axially apart from the sun drive teeth 78 and the inner drive formations 86 are meshingly engaged with the input drive teeth 82 on the input shaft 16. In more detail, when the range shift collar 84 is in the high position, power is transferred (arrow 94) from the input shaft 16, into the range shift collar 84, into the planetary carrier 66, and transferred to the differential housing 40. Next, power is transferred from the differential housing 40 through the differential pinion gears 36 to the differential side gears 42, 43 and to the right and left output shafts 50, 52.

The range shift collar 84 is shown in the neutral position in FIG. 6. Referring to FIG. 6, the range shift collar 84 is positioned axially disengaged from both the sun gear 60 and the planetary carrier 66 so that power is not transferred to the front differential 22. In the neutral position, the high drive formations 92 are spaced axially apart from the carrier drive teeth 76, the low drive formations 88 are spaced axially apart from the sun drive teeth 78, and the inner drive formations 86 are meshingly engaged with the input drive teeth 82 on the input shaft 16. As such, power is transferred from the input shaft 16 to the range shift collar 84, as illustrated by arrow 95, without the power being transferred to the front differential 22. The range shift collar 84 is moved through the neutral position as the range shift collar 84 is repositioned between the high position and the low position so that the planetary gear set 58 and the front differential 22 are disengaged prior to the range shift collar 84 engaging with the carrier drive teeth 76 or the sun drive teeth 78.

The range shift collar 84 is shown in the low position (low gear mode) in FIG. 7. Referring to FIG. 7, the range shift collar 84 is positioned axially so that the low drive formations 88 are meshingly engaged with the sun drive teeth 78 on the sun shaft 67, providing low gear range power to the front differential 22, as illustrated by arrow 96. The high drive formations 92 are spaced axially apart from the carrier drive teeth 76 on the planetary carrier 66 and the inner drive formations 86 are meshingly engaged with the input drive teeth 82 on the input shaft 16. In more detail, when the range shift collar 84 is in the low position, power is transferred (arrow 96) from the input shaft 16, into the range shift collar 84, into the sun shaft 67, through the sun gear 60, through the planet gears 64, into the planetary carrier 66, and transferred to the differential housing 40. Next, power is transferred from the differential housing 40 through the differential pinion gears 36 to the differential side gears 42, 43, and to the right and left output shafts 50, 52.

Referring to FIGS. 1 and 3, the PTU gear set 18 is configured to transfer power from the input shaft 16 to the prop shaft 26 when the AWD system 10 transfers power to the RDM 14. In more detail, the PTU gear set 18 includes a main shaft 97 rotatably supports and axially spaced apart bearings 98, 100 which in turn rotatably support the input shaft 16. In addition, the main shaft 97 is radially and axially supported by axially spaced apart bearings 102, 104, which in turn are supported by the stationary housing 32. The main shaft 97 also includes an inboard portion 106 that is formed with mainshaft drive formations 108, which are formed as drive teeth formed on an inner circumference or surface of the main shaft 97 and face radially inwardly. However, it will be appreciated that the mainshaft drive formations 108 might be formed with alternate configurations, such as facing radially outwardly, radially inwardly, or in an axial direction without varying the scope of the present invention.

The PTU gear set 18 also includes a main ring gear 110 radially and axially supported on the inboard portion 106 of the main shaft 97, either integral therewith or as a separate component, such that rotation of the main shaft 97 rotates the main ring gear 110. It will be appreciated that the main ring gear 110 might be a hypoid ring gear, a spiral bevel gear, a straight bevel gear, and the like without altering the scope of the present invention. Shown in FIG. 1, the PTU gear set 18 also includes a hypoid pinion gear 112 in meshing engagement with the main ring gear 110. The PTU gear set 18 also includes a pinion shaft 114 extending axially from the hypoid pinion gear 112, either integral therewith or as a separate component, such that rotation of the hypoid pinion gear 112 rotates the pinion shaft 114. The pinion shaft 114 is radially and axially supported on the stationary housing 32 by axially spaced apart bearings 116, 118 such that the pinion shaft 114 is free to rotate. The PTU 12 might also include a prop shaft coupler 120 non-rotatably coupled to a distal end of the pinion shaft 114 and configured to be fixedly coupled (i.e., non-rotatably coupled) to the prop shaft 26 such that rotation of the pinion shaft 114 causes the prop shaft 26 to rotate. It will be appreciated that the pinion shaft 114 might be operatively coupled to the prop shaft 26 using other known methods without altering the scope of the present invention.

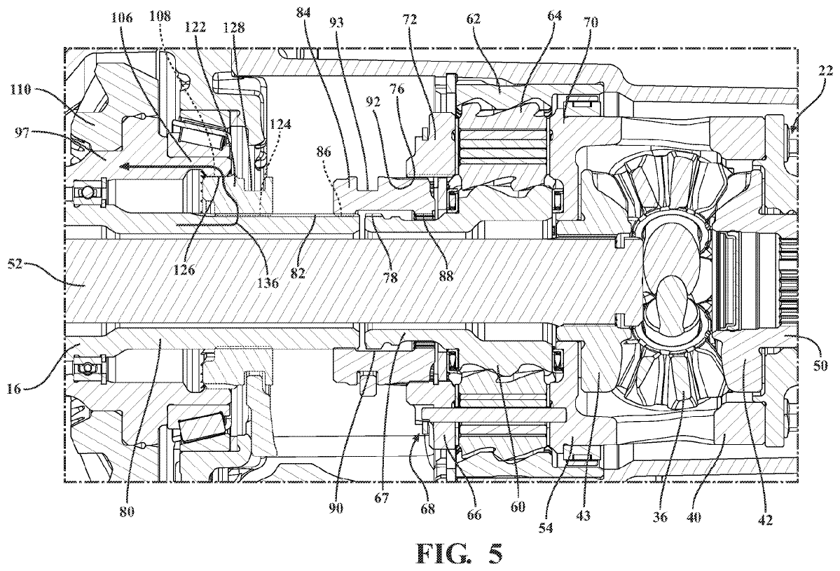

Depicted in FIGS. 1, and 3-5, the PTU 12 also includes a takeoff shift collar 122, alternately described as an all-wheel drive (AWD) shift collar 122. The takeoff shift collar 122 is splined to the input shaft 16 such that the takeoff shift collar 122 rotates with the input shaft 16 while being axially slidable relative thereto. The takeoff shift collar 122 is displaceable axially between two axially spaced positions corresponding to a disengaged mode (FIG. 4) and an engaged mode (FIG. 5). The takeoff shift collar 122 is configured to selectively couple the input shaft 16 to the main shaft 97 in order to transfer power to the RDM 14. The takeoff shift collar 122 is displaceable axially by the actuator assembly 28 which also is configured to axially displace the range shift collar 84. However, it will be appreciated that the takeoff shift collar 122 might be axially displaced by a different actuator than the actuator assembly 28 for the range shift collar 84 without altering the scope of the present invention.

Referring to FIG. 4, the takeoff shift collar 122 includes a main body that is formed with input drive formations 124, which are preferably formed as drive teeth formed on an inner circumference or surface and face radially inwardly. The input drive formations 124 are meshingly engaged with the input drive teeth 82 on the end flange 80 of the input shaft 16 while allowing the takeoff shift collar 122 to be displaceable axially along the input drive teeth 82 so as to remain engaged therewith in both of the disengaged mode and the engaged mode. In addition, the takeoff shift collar 122 includes output drive formations 126 which are formed as drive teeth that face radially outwardly from an outer circumference or surface of the takeoff shift collar 122. However, it will be appreciated that the output drive formations 126 might be formed with alternate configurations, such as facing radially outwardly, radially inwardly, or in an axial direction without varying the scope of the present invention. The output drive formations 126 are configured to meshingly engage with the mainshaft drive formations 108 on the main shaft 97 when the takeoff shift collar 122 is repositioned axially to transfer power through the main shaft 97 and provide power to the RDM 14. The takeoff shift collar 122 also includes a takeoff channel 128 extending circumferentially around an outer diameter or surface of the takeoff shift collar 122. The takeoff channel 128 is configured to be operatively coupled to the actuator assembly 28 allowing the takeoff shift collar 122 to be repositioned axially between the engaged position and the disengaged position, corresponding the disengaged mode and the engaged mode, respectively. It will be appreciated that the input and output drive formations 124, 126 and the mainshaft drive formations 108 may formed like gear teeth but other configurations of drive formations might be provided without altering the scope of the present invention.

The takeoff shift collar 122 is shown in the disengaged position in FIG. 4. Referring to FIG. 4, the takeoff shift collar 122 is positioned axially so that the output drive formations 126 are axially spaced apart from the mainshaft drive formations 108 on the main shaft 97. Power is transferred from the input shaft 16 to the takeoff shift collar 122 through the input drive formations 124, as illustrated by arrow 134. However, the takeoff shift collar 122 does not transfer power to the main shaft 97 when the takeoff shift collar 122 is in the disengaged position which also prevents power from being supplied to the RDM 14.

The takeoff shift collar 122 is shown in the engaged position in FIG. 5. Referring to FIG. 5, the takeoff shift collar 122 is positioned axially so that the output drive formations 126 are meshingly engaged with the mainshaft drive formations 108 on the main shaft 97. In addition, the input drive formations 124 are meshingly engaged with the input drive teeth 82 on the input shaft 16. As such, power is transferred from the input shaft 16, through the takeoff shift collar 122, to the main shaft 97, as illustrated by arrow 136. Next, the main shaft 97 transfers the supplied power through the main ring gear 110, to the hypoid pinion gear 112, through the pinion shaft 114, and through the prop shaft coupler 120 to deliver power to the RDM 14, as illustrated by arrow 138 in FIG. 1.

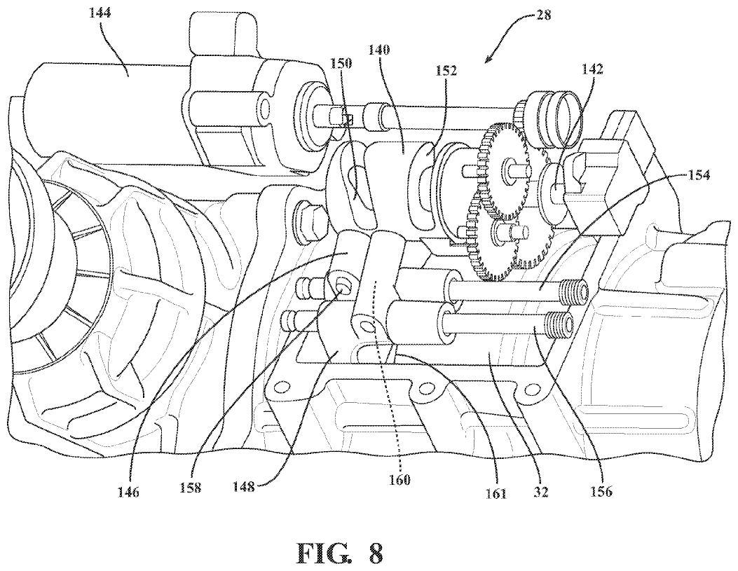

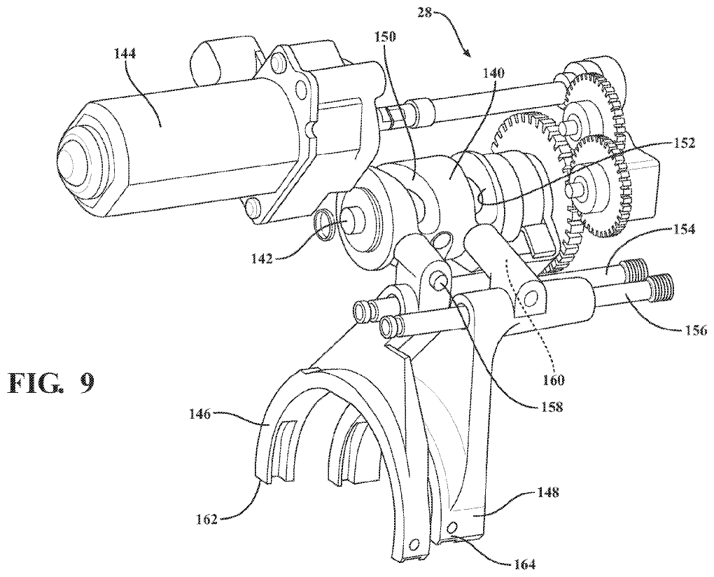

Referring to FIGS. 8 and 9, the actuator assembly 28 is configured to axially reposition the range shift collar 84 between the high position (high gear mode) and the low position (low gear mode). In addition, the actuator assembly 28 is configured to axially reposition the takeoff shift collar 122 between the disengaged mode and the engaged mode. The actuator assembly 28 is a barrel cam actuator assembly, which functions similarly to certain commonly known barrel cam actuator assemblies. The actuator assembly 28 includes a barrel cam 140, a barrel cam shaft 142, a barrel cam motor 144, a takeoff shift fork 146, and a range shift fork 148. In brief, the barrel cam 140 is supported on the barrel cam shaft 142 and configured to rotate therewith. The actuator assembly 28 also includes a spring (not shown) operatively coupled between the barrel cam shaft 142 and the barrel cam 140 configured to wind up in case of a blocked shift actuation. The barrel cam 140 includes a takeoff cam slot 150 and a range cam slot 152 which are axially spaced apart, extend in a circumferential direction, and include respective cam profiles. The barrel cam motor 144 is operatively coupled to the barrel cam shaft 142 and configured to selectively rotate the barrel cam shaft 142 which in turn rotates the barrel cam 140. The takeoff shift fork 146 and the range shift fork 148 are slidably coupled to respective support shafts 154, 156. In addition, the takeoff shift fork 146 and the range shift fork 148 are operatively coupled to the takeoff cam slot 150 and the range cam slot 152, respectively, by pins 158, 160. Depicted in FIG. 8, the barrel cam 140, the barrel cam motor 144, and the support shafts 154, 156 are supported on an exterior surface of the stationary housing 32. The takeoff shift fork 146 and the range shift fork 148 extend radially through a slot 161 extending through the stationary housing 32. The slot 161 provides clearance for the takeoff shift fork 146 and the range shift fork 148 to be repositioned axially.

Referring to FIGS. 7 and 9, the takeoff shift fork 146 has a lower end 162 fixedly coupled to the takeoff channel 128 in the takeoff shift collar 122. In addition, the range shift fork 148 has a lower end 164 fixedly coupled to the range channel 93 in the range shift collar 84. In operation, the barrel cam motor 144 selectively rotates the barrel cam 140 which causes the pins 158, 160 to be repositioned axially as the pins 158, 160 travel along the cam surfaces in the respective takeoff and range cam slots 150, 152, causing the takeoff shift fork 146 and the range shift fork 148 to be repositioned axially along the support shafts 154, 156. The cam profile of the takeoff cam slot 150 is selected to reposition the takeoff shift fork 146 and the attached takeoff shift collar 122 between the engaged position (FIG. 5) and the disengaged position (FIG. 4). In addition, the cam profile of the range cam slot 152 is selected to reposition the range shift collar 84 between the high position (high gear mode, FIG. 4) and the low position (low gear mode, FIG. 7). As such, the axial position of the takeoff shift fork 146 and the range shift fork 148 are controlled by the rotational position of the barrel cam 140. The barrel cam 140 is configured to reposition the takeoff shift collar 122 between the engaged position and the disengaged position. Further, the barrel cam 140 is configured to reposition the range shift collar 84 between high, low, and neutral positions.

The RDM 14 is configured to receive power from the PTU 12 and transfer the power to the rear wheels. Referring to FIG. 2, the RDM 14 includes a stationary housing 168, a prop shaft flange 170, an input hub 172, a torque transfer coupling 174, the clutch drum 20, and a hypoid pinion shaft 176. The stationary housing 168 includes an internal cavity for containing and supporting certain components of the RDM 14. The prop shaft flange 170 is fixedly coupled to a distal end of the input hub 172 and configured to be fixedly coupled to one end of the prop shaft 26. The input hub 172 is radially and axially supported within the stationary housing 168 by axially spaced apart bearings 177, 178 and able to rotate freely in response to rotation of the prop shaft flange 170 and the attached prop shaft 26.

A proximal end of the input hub 172 is operatively coupled to the torque transfer coupling 174 which in turn is configured to selectively transfer power from the input hub 172 to the clutch drum 20 when the torque transfer coupling is in an engaged condition. The clutch drum 20 is non-rotatably coupled to a distal end of the hypoid pinion shaft 176. The torque transfer coupling 174 includes a hydraulic piston 179, a friction clutch 180, a hydraulic motor 182, and a hydraulic pump 184. The friction clutch 180 includes a plurality of friction plates 185 which are axially spaced apart when the friction clutch 180 is in a disengaged condition.

The hydraulic motor 182 and the hydraulic pump 184 are configured to selectively provide hydraulic pressure to the hydraulic piston 179. Hydraulic pressure applied to the hydraulic piston 179 causes the friction plates 185 to frictionally engage with the adjacent friction plate 185 causing the friction clutch 180 to engage, allowing power to be transferred from the input hub 172, through the friction clutch 180, and to the hypoid pinion shaft 176. The torque transfer coupling 174 also includes a return spring 186 which disengages the friction clutch 180 by axially spacing apart the friction plates 185 when hydraulic pressure is removed from the hydraulic piston 179 and the torque transfer coupling is in a disengaged condition. As such, the return spring 186 ensures that power is not transferred between the clutch drum 20 and the input hub 172 unless the AWD system 10 activates the hydraulic motor 182 causing the hydraulic pump 184 to provide hydraulic pressure to the hydraulic piston 179 which engages the friction clutch 180. The torque transfer coupling 174 is normally in a disconnected condition which prevents power transfer between the input hub 172 and the clutch drum 20. When hydraulic pressure is removed from the hydraulic piston 179, the return spring 186 creates additional separation between the friction plates 185 within the friction clutch 180 in order to reduce the residual drag torque across the friction clutch 180 (compared to other known couplings). The return spring 186 allows the AWD system 10 drag torque to become low enough to stop rotation of the driveline components.

Depicted in FIG. 2, the hypoid pinion shaft 176 is radially and axially supported within the stationary housing 168 by axially spaced apart bearings 192, 194 and able to rotate freely in response to rotation of the clutch drum 20. The RDM 14 also includes a hypoid pinion gear 196 supported on a proximal end of the hypoid pinion shaft 176, either integral therewith or as a separate component, such that rotation of the hypoid pinion shaft 176 rotates the hypoid pinion gear 196.

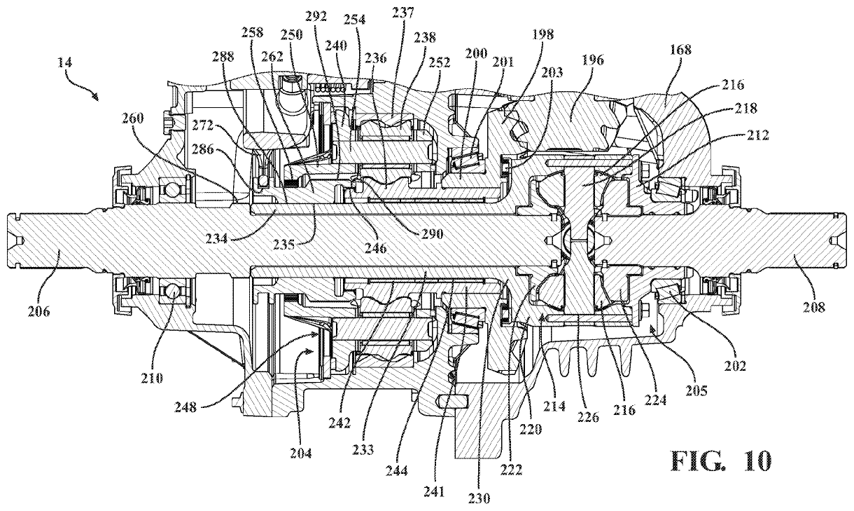

The RDM 14 also includes a main ring gear 198 in meshed engagement with the hypoid pinion gear 196 such that the main ring gear 198 rotates in response to rotation of the hypoid pinion gear 196. It will be appreciated that the main ring gear 198 might be a hypoid ring gear, a spiral bevel gear, a straight bevel gear, and the like without altering the scope of the present invention. The main ring gear 198 is radially and axially supported on an inboard portion of a ring gear hub 200. either integral therewith or as a separate component, such that rotation of the main ring gear 198 rotates the ring gear hub 200. The ring gear hub 200 is radially and axially supported on the stationary housing 168 by bearing 201. Referring to FIG. 10, the main ring gear 198 is also supported by bearings 202 and 203, which are further described below.

The RDM 14 also includes a planetary gear set 204, a rear differential 205, a left output shaft 206, and a right output shaft 208. The planetary gear set 204 is configured to selectively provide power in a high gear range and a low gear range to the rear differential 205 which transfers the power to the left and right output shafts 206, 208. Referring to FIG. 10. the left output shaft 206 is radially and axially supported by a bearing 210 which in turn is supported by the stationary housing 168. The right output shaft 208 is radially and axially supported within the stationary housing 168 by a contacting journal formed on an outer surface of a differential cover 212, further described below. In turn, the differential cover 212 is radially and axially supported by bearing 202. The output shafts 206, 208 may be any combination of output shafts, half shafts, link shafts, etc., as is known in the art. The output shafts 206, 208 thereby rotate with and selectively drive vehicle wheels connected thereto.

Depicted in FIG. 10, the rear differential 205 includes a pinion gear assembly 214 rotatably supported within the stationary housing 168. The pinion gear assembly 214 includes opposing differential pinion gears 216, a pinion shaft 218, a differential housing 220, and opposing differential side gears 222, 224. The differential pinion gears 216 are rotatably connected together by the pinion shaft 218 which is mechanically connected to the differential housing 220. In addition, the differential pinion gears 216 are in meshed engagement with the differential side gears 222, 224 such that torque can be transferred from the differential housing 220 to the differential pinion gears 216 and then to the differential side gears 222, 224. The pinion shaft 218 rotatably supports the differential pinion gears 216 on the ends thereof and rotates with the differential pinion gears 216 as the differential pinion gears 216 travel about the differential side gears 222, 224. The rear differential 205 further includes a connector pin 226 fixedly coupling the pinion shaft 218 to the differential housing 220 so that the pinion gears 216, the pinion shaft 218, and the differential housing 220 of the rear differential 205 all travel together about the same shaft axis as the side gears 222, 224. The differential housing 220 is supported radially and axially by bearings 201, 202, and 203 and can spin freely within the stationary housing 168. It will be appreciated that the bearings 201 and 202 might be tapered roller bearings or might be alternate types of known bearings.

Referring to FIG. 10, the differential side gears 222, 224 are supported by the differential housing 220 and operate to drive torque to any combination of left and right output shafts 206, 208. The output shafts 206, 208 thereby rotate with and selectively drive vehicle wheels connected thereto. The differential housing 220 includes a housing end flange 230 and the differential cover 212. The differential housing 220 also includes a differential shaft 233 extending axially from an inboard end of the housing end flange 230, either integral therewith or as a separate component, such that rotation of the differential shaft 233 rotates the housing end flange 230. The differential shaft 233, the housing end flange 230, and the differential cover 212 are open to allow the output shafts 206, 208 attached to the side gears 222, 224 to extend axially therefrom for driving of the wheels. The differential shaft 233, the housing end flange 230, and the differential cover 212 are rotatably supported by the bearings 201 and 202 which support the rear differential 205. The differential shaft 233, the housing end flange 230, and the differential cover 212 also provide support for the right output shaft 208. To selectively drive the rear differential 205, the differential shaft 233 includes a flange portion 234 having drive formations preferably formed as drive teeth 235 about an outer circumference or surface of the flange portion 234 which face radially outwardly and extend in an axial direction.

Referring to FIG. 2, the bearings 201 and 202 are tapered roller bearings which radially and axially support the differential housing 220 and the differential cover 212, respectively. Bearings 201, 202, and 203 also radially and axially support the main ring gear 198. The main ring gear 198 and the differential housing 220 are in a stacked arrangement between the bearings 201, 202. In addition, the hypoid pinion gear 196, the hypoid pinion shaft 176, the friction clutch 180, the input hub 172, and the clutch drum 20 are generally aligned on an axis spaced between the bearings 201, 202.

Due to the connection of the output shafts 206, 208 and side gears 222, 224 to the wheels, the output shafts 206, 208 and side gears 222, 224 will rotate when the wheels rotate. The side gears 222, 224 are in meshed engagement with the pinion gears 216 and the ring gear hub 200 is engageable with the differential housing 220 such that torque can transfer from the ring gear hub 200, through the planetary gear set 204, through the differential housing 220, the differential pinion gears 216, and then the side gears 222, 224 to thereby drive the output shafts 206, 208.

Also shown in FIG. 10, the planetary gear set 204 defines alternate paths of torque transmission between the ring gear hub 200 and the rear differential 205, which corresponds to the high gear range and the low gear range. The planetary gear set 204 includes a sun gear 236, a planetary ring gear 237, a set of planet gears 238, and a planetary carrier 240. The sun gear 236 is integrally formed with a sun shaft 241 which is rotatably supported on the outer circumference of the differential shaft 233 by bearings 242, 244. In addition, the sun shaft 241 is supported on the ring gear hub 200, either integral therewith or as a separate component, such that rotation of the ring gear hub 200 rotates the sun shaft 241. To selectively drive the rear differential 205, the sun shaft 241 includes drive formations formed as drive teeth 246 adjacent an inboard end. In FIG. 10, the sun drive teeth 246 are formed about an outer circumference or surface of the sun shaft 241 and face radially outwardly. However, it will be appreciated that the sun drive teeth 246 might be formed with alternate configurations, such as facing radially outwardly, radially inwardly, or in an axial direction without varying the scope of the present invention.

The planetary ring gear 237 is grounded to the stationary housing 168 and is concentric to the sun gear 236 in radially spaced, opposing relation. The set of planet gears 238 are meshed radially with the sun gear 236 and the planetary ring gear 237. The planet gears 238 are mounted to and supported by the planetary carrier 240 to form a planetary carrier assembly 248 that is rotatably supported by the sun gear 236. The planetary carrier 240 has an outboard carrier section 250, an inboard carrier section 252, and circumferentially spaced support shafts 254 for rotatably supporting the planet gears 238.

To selectively drive the rear differential 205, the outboard carrier section 250 includes drive formations formed as drive teeth 258 adjacent an outboard end. In FIG. 10, the carrier drive teeth 258 are formed about an inner circumference or surface of the outboard carrier section 250 and face radially inwardly. However, it will be appreciated that the carrier drive teeth 258 might be formed with alternate configurations, such as facing radially outwardly, radially inwardly, or in an axial direction without varying the scope of the present invention.

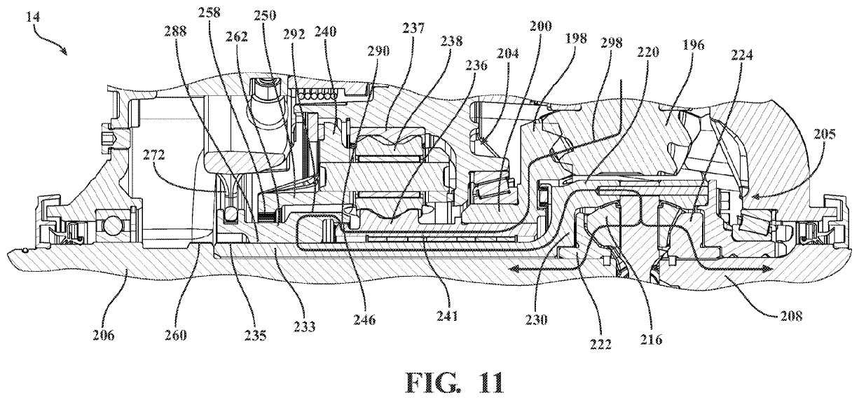

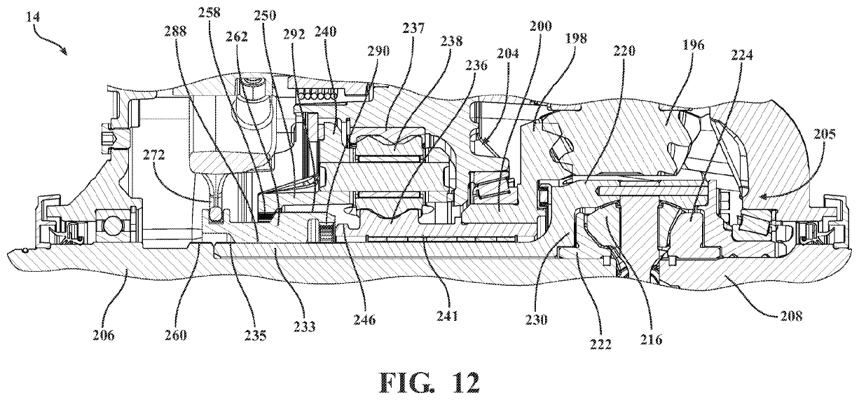

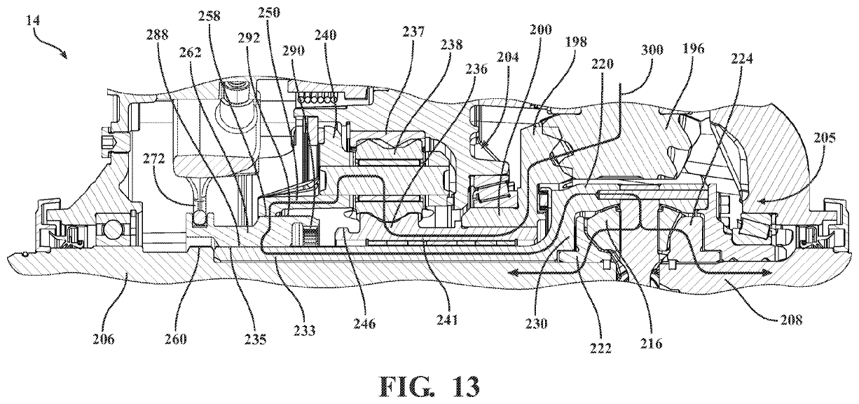

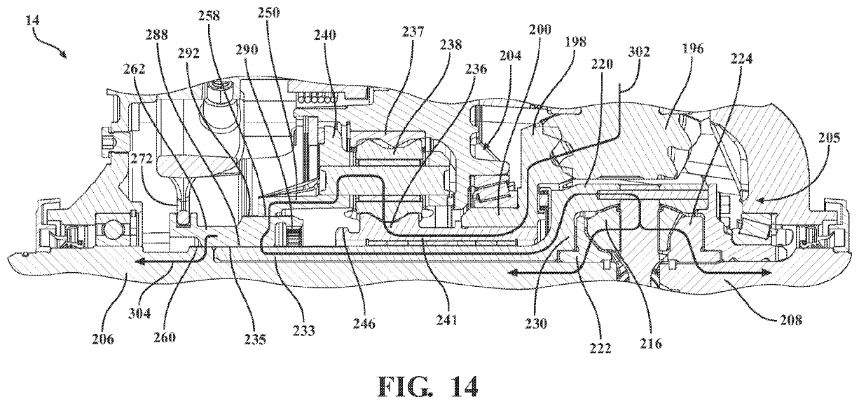

To selectively lock the left output shaft 206 and prevent the left output shaft 206 from rotating relative to the right output shaft 208, the left output shaft 206 includes locking drive teeth 260 that face radially outwardly from an outer circumference or surface of the left output shaft 206, as shown in FIG. 10. However, it will be appreciated that the locking drive teeth 260 might be formed with alternate configurations, such as facing radially outwardly, radially inwardly, or in an axial direction without varying the scope of the present invention. The RDM 14 also includes a shift collar 262 which is splined to the differential shaft 233 such that the shift collar 262 rotates with the differential shaft 233 while being axially slidable relative thereto. The shift collar 262 is displaceable axially between three axially spaced positions corresponding to 4HI mode (4HI position, FIG. 11), 4LO mode (4LO position, FIGS. 13), and 4 LO-Lock mode (4LO-Lock position, FIG. 14). The shift collar 262 passes through a neutral position (FIG. 12) as the shift collar 262 moves between 4HI and 4LO modes.

Depicted in FIG. 2, the shift collar 262 is displaceable axially by a suitable actuator assembly 264, such as a hydraulic actuator that is electrically controlled by a vehicle controller, a barrel cam actuator, a solenoid, and the like. The exemplary actuator assembly 264 is a barrel cam actuator assembly as is generally known in the art. The actuator assembly 264 includes a barrel cam 266, a barrel cam shaft 268, a cam driver 269, a barrel cam motor 270, a block spring 271, a shift fork 272, and a pin 274. The barrel cam 266 is fixedly coupled to the barrel cam shaft 268 and rotates with the barrel cam shaft 268. In addition, the barrel cam 266 includes a cam slot 280 which extends in a circumferential direction. The barrel cam motor 270 is operatively coupled to the cam driver 269 which in turn is operatively coupled to the barrel cam shaft 268 via the block spring 271. The barrel cam motor 270, the cam driver 269, and the block spring 271 are configured to selectively rotate the barrel cam shaft 268 about the shaft longitudinal axis, as further described below. The shift fork 272 is operatively coupled to the cam slot 280 by the pin 274. In addition, the shift fork 272 has a fork end 284 fixedly coupled to a fork channel 286 extending circumferentially around an outer circumference or surface of the shift collar 262. The axial position of the shift collar 262 is determined by the rotational position of the barrel cam 266 as the pin 274 travels along the cam slot 280. The barrel cam motor 270 selectively rotates the cam driver 269 which in turn rotates the block spring 271 and the barrel cam 266 to reposition the shift fork 272 and the attached shift collar 262 between the 4HI, 4LO, and 4LO-Lock positions. When the shift fork 272 is blocked from being repositioned in response to the actuation of the barrel cam motor 270, the block spring 271 is wound up by the motion of the cam driver 269 and applies rotationally pressure on the barrel cam 266. As soon as the shift fork 272 is free to move in the axial direction (i.e., is “unblocked), the tension in the block spring 271 causes the barrel cam 266 to rotate and reposition the shift fork 272 to the new axial position, which in turn repositions the shift collar 262.

Referring to FIG. 10, the shift collar 262 includes a main body that is formed with output drive formations 288, which are formed as drive teeth formed on an inner circumference or surface and face radially inwardly. However, it will be appreciated that the output drive formations 288 might be formed with alternate configurations, such as facing radially outwardly, radially inwardly, or in an axial direction without varying the scope of the present invention. The output drive formations 288 are meshingly engaged with the differential drive teeth 235 on the differential shaft 233 while allowing the shift collar 262 to be displaceable axially along the differential drive teeth 235 so as to remain engaged therewith in the 4HI mode, the 4LO mode, and the 4LO-Lock mode. As such, the shift collar 262 is able to transfer power through the differential shaft 233 to the housing end flange 230 and into the differential housing 220. In addition, the locking drive teeth 260 on the left output shaft 206 are radially aligned with the drive teeth on the differential shaft 233. The shift collar 262 is slidable axially allowing the output drive formations 288 to meshingly engage simultaneously with both the locking drive teeth 260 and the differential drive teeth 235, providing the 4LO-Lock mode shown in FIG. 14.

Depicted in FIG. 10, the shift collar 262 also includes lower drive formations 290, which are formed as drive teeth formed on an inner circumference or surface and face radially inwardly. However, it will be appreciated that the lower drive formations 290 might be formed with alternate configurations, such as facing radially outwardly, radially inwardly, or in an axial direction without varying the scope of the present invention. The lower drive formations 290 are meshingly engaged with the sun drive teeth 246 on the sun shaft 241 when the shift collar 262 is positioned axially to transfer power from the main ring gear 198 and provide 4HI power to the rear differential 205.

Shown in FIG. 10, the shift collar 262 also includes upper drive formations 292, which are formed as drive teeth on an outer circumference or surface and face radially outwardly. However, it will be appreciated that the upper drive formations 292 might be formed with alternate configurations, such as facing radially outwardly, radially inwardly, or in an axial direction without varying the scope of the present invention. The upper drive formations 292 are configured to meshingly engage with the carrier drive teeth 258 on the outboard carrier section 250 when the shift collar 262 is positioned axially to transfer power from the planetary carrier 240 and provide 4LO power to the rear differential 205. In addition, the shift collar 262 is slidable axially from the 4LO position to the 4LO-Lock position. When the shift collar 262 is in the 4LO-Lock position, the output drive formations 288 meshingly engage with the locking drive teeth 260 on the left output shaft 206 while maintaining the upper drive formations 292 in meshing engagement with the carrier drive teeth 258 on the outboard carrier section 250 and maintaining the output drive formations 288 in meshing engagement with the differential drive teeth 235 on the differential shaft 233.

It will be appreciated that the drive teeth 246, 235, 258, 260 and the drive formations 290, 288, 292 may formed like gear teeth but other configurations of drive formations might be provided without altering the scope of the present invention. Generally, the locking drive teeth 260, the differential drive teeth 235, and the output drive formations 288 located at or about the same radial distance from the central axis extending through the left output shaft 206 and the right output shaft 208, although the distances may vary to vary torque transmission characteristics. Further, the carrier drive teeth 258 and the upper drive formations 292 are located radially offset from the locking drive teeth 260, the differential drive teeth 235, and the output drive formations 288. In addition, the lower drive formations 290 and the sun drive teeth 246 are located radially offset from the remaining drive teeth 258, 235, 260 and drive formations 288, 292. However, it will be appreciated that the radial positions and axial positions of the drive teeth 246, 258, 235, 260 and the drive formations 290, 288, 292 might vary without altering the scope of the present invention.

In operation, the AWD system 10 selectively provides power to the main shaft 97 in the PTU 12 when the takeoff shift collar 122 is in engaged position, as illustrated by arrow 136 in FIG. 5. Referring to FIG. 1, power supplied to the main shaft 97 is transferred through the main ring gear 110, the hypoid pinion gear 112, and to the prop shaft 26, as illustrated by arrow 138. Depicted in FIG. 2, power is transferred from the prop shaft 26 to the input hub 172 in the RDM 14, as illustrated by arrow 294. Power is not transferred between the input hub 172 and the clutch drum 20 while the torque transfer coupling 174 is disengaged.

To engage the RDM 14 and transfer power to the rear differential 205 from the prop shaft 26, the AWD system 10 activates the hydraulic motor 182 which causes the hydraulic pump 184 to apply hydraulic pressure to the hydraulic piston 179 which in turn applies pressure on the friction clutch 180 causing the friction clutch 180 to engage. After the friction clutch 180 is engaged, power supplied to the input hub 172 is transferred through the friction clutch 180, to the clutch drum 20, through the hypoid pinion shaft 176, the hypoid pinion gear 196, and to the main ring gear 198, as illustrated by arrow 296 in FIG. 2.

The AWD system 10 is configured to selectively place the RDM 14 in the 4HI, 4LO, and the 4LO-Lock modes by repositioning the shift collar 262 axially between three spaced apart positions, i.e., the 4HI, 4LO, and 4LO-Lock positions, respectively. The RDM 14 is shown in the 4HI mode with the shift collar 262 in the 4HI position in FIG. 11, which transfers 4HI range power to the rear differential 205. In the 4HI mode, the lower drive formations 290 of the shift collar 262 are meshingly engaged with the sun drive teeth 246, the output drive formations 288 are meshingly engaged with the differential drive teeth 235 and spaced axially apart from the locking drive teeth 260. In addition, the upper drive formations 292 on the shift collar 262 are spaced axially apart from the carrier drive teeth 258. In more detail, when the RDM 14 is in the 4HI mode shown in FIG. 11, the power supplied to the hypoid pinion gear 196 (arrow 296 in FIG. 2) is transferred through the main ring gear 198 through the sun shaft 241 and transferred to the shift collar 262 through the sun drive teeth 246 meshingly engaged with the lower drive formations 290. Next, 4HI range power is transferred from the shift collar 262 through the output drive formations 288 meshingly engaged with the differential drive teeth 235 to the differential shaft 233, to the housing end flange 230, transferred to the differential housing 220, through the differential pinion gears 216 to the side gears 222, 224 and finally to the output shafts 206, 208, as illustrated by arrow 298.

The RDM 14 is shown in the 4LO mode with the shift collar 262 in the 4LO position in FIG. 13, which transfers 4LO range power to the rear differential 205. In the 4LO mode, the upper drive formations 292 on the shift collar 262 are meshingly engaged with the carrier drive teeth 258 and the output drive formations 288 are meshingly engaged with the differential drive teeth 235 and spaced axially apart from the locking drive teeth 260. In addition, the lower drive formations 290 on the shift collar 262 are spaced axially apart from the sun drive teeth 246. In more detail, when the RDM 14 is in the 4LO mode shown in FIG. 13, the power supplied to the hypoid pinion gear 196 (arrow 296 in FIG. 2) is transferred through the main ring gear 198 through the sun shaft 241, through the sun gear 236, the planet gears 238, and into the planetary carrier 240. Next, 4LO range power is transferred from the outboard carrier section 250 through the carrier drive teeth 258 meshingly engaged with the upper drive formations 292, and into the shift collar 262. Next, 4LO range power is transferred from the shift collar 262 through the output drive formations 288 meshingly engaged with the differential drive teeth 235 to the differential shaft 233 and the housing end flange 230, and transferred to the differential housing 220, through the differential pinion gears 216, to the side gears 222, 224, and finally to the output shafts 206, 208, as illustrated by arrow 300.

When transitioning between the 4HI mode and the 4LO mode, the shift collar 262 is repositioned axially into a neutral position, as illustrated in FIG. 12, prior to moving to the 4HI or 4LO positions. In the neutral position, the carrier drive teeth 258 are spaced axially apart from the upper drive formations 292, the sun drive teeth 246 are spaced axially apart from lower drive formations 290, the output drive formations 288 are engaged with the differential drive teeth 235, and the output drive formations 288 are disengaged from the locking drive teeth 260. The shift collar 262 is repositionable to either of the 4HI position or the 4LO position after the shift collar 262 has disengaged from both the carrier drive teeth 258 and the sun drive teeth 246. The output drive formations 288 on the shift collar 262 maintain engagement with the differential drive teeth 235 as the shift collar 262 is moved axially between the 4HI and 4LO positions.

The RDM 14 is shown in the 4LO-Lock mode with the shift collar 262 in the 4LO-Lock position in FIG. 14, which transfers 4LO power to the rear differential 205 and locks the left output shaft 206 to the rear differential 205. Locking the left output shaft 206 to the rear differential 205 prevents the left output shaft 206 from rotating relative to the right output shaft 208 and allows power transfer directly from the shift collar 262 to the left output shaft 206, or through the rear differential 205 to the right output shaft 208, even if the opposite side has limited or no traction at the wheel. In the 4LO-Lock mode, the upper drive formations 292 on the shift collar 262 are meshingly engaged with the carrier drive teeth 258 and the output drive formations 288 are meshingly engaged with both of the differential drive teeth 235 and the locking drive teeth 260. In addition, the lower drive formations 290 on the shift collar 262 are spaced axially apart from the sun drive teeth 246. The RDM 14 is repositionable to the 4LO-Lock mode when the RDM 14 is in the 4LO mode by axially sliding the shift collar 262 to the 4LO-Lock position from the 4LO position. The upper drive formations 292 maintain engagement with the carrier drive teeth 258 as the shift collar 262 is repositioned axially between the 4LO and 4LO-Lock positions. In addition, the output drive formations 288 maintain meshing engagement with the differential drive teeth 235 while the shift collar 262 is repositioned axially to meshingly engage the output drive formations 288 with the locking drive teeth 260.

In more detail, when the RDM 14 is in the 4LO-Lock mode shown in FIG. 14, the power supplied to the hypoid pinion gear 196 (arrow 296 in FIG. 2) is transferred through the main ring gear 198 through the sun shaft 241, through the sun gear 236, through the planet gears 238, and into the planetary carrier 240. Next, 4LO power is transferred from the outboard carrier section 250 through the carrier drive teeth 258 meshingly engaged with the upper drive formations 292, and into the shift collar 262. Next, 4LO power is transferred from the shift collar 262 through the output drive formations 288 meshingly engaged with the differential drive teeth 235 to the differential shaft 233 and the housing end flange 230, and transferred to the differential housing 220, through the differential pinion gears 216, to the side gears 222, 224, and finally to the output shafts 206, 208, as illustrated by arrow 302. However, the shift collar 262 also locks the left output shaft 206 rotationally with the differential shaft 233 and the planetary carrier 240 since the output drive formations 288 are in meshing engagement with both the locking drive teeth 260 and the differential drive teeth 235 in addition to the upper drive formations 292 in meshing engagement with the carrier drive teeth 258. As such, 4LO power is also transferred directly to the left output shaft 206, as illustrated by arrow 304.

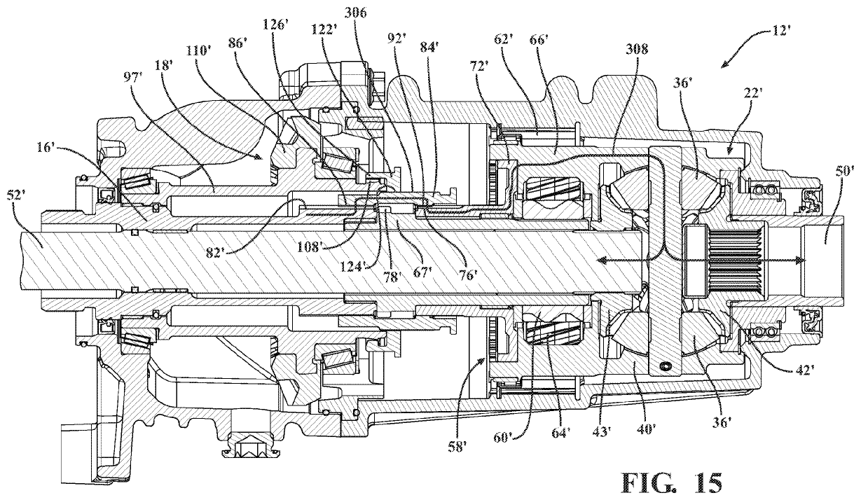

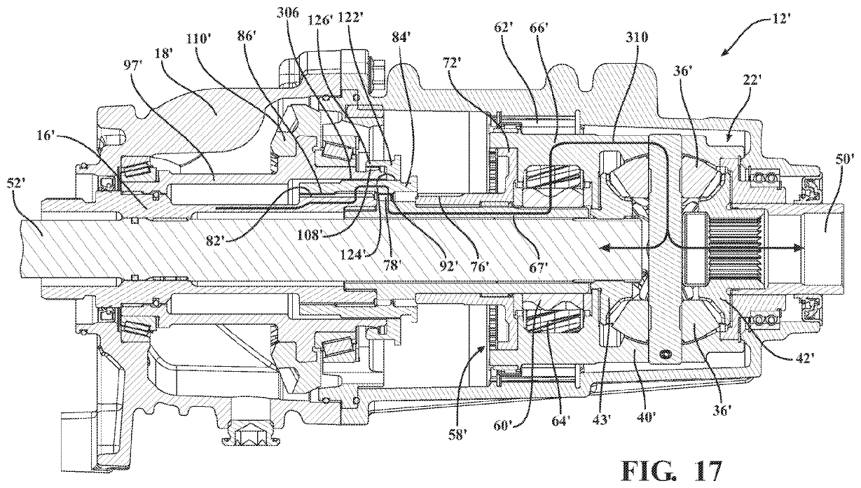

A second embodiment of the PTU 12′ is shown in FIGS. 15-18, which uses like primed reference numerals representing similar elements as those described above. Referring to FIG. 15, in this modified PTU 12′, the range shift collar 84′ includes inner drive formations 86′ which are splined to the input drive teeth 82′ on the input shaft 16′, similar as in the embodiment shown above in FIG. 3. In addition, the range shift collar 84′ includes drive formations 92′ configured to meshingly engage with the carrier drive teeth 76′ to provide high gear range power to the front differential 22′ when the range shift collar 84′ is in a high position (FIG. 15). Further, the drive formations 92′ are also configured to meshingly engage with the sun drive teeth 78′ to deliver low gear range power to the front differential 22′ when the range shift collar 84′ is axially repositioned to the low position (FIG. 17). In contrast to the embodiment shown in FIG. 3, the input drive formations 124′ on the takeoff shift collar 122′ are splined to upper drive formations 306 formed on the range shift collar 84′. The takeoff shift collar 122′ also includes output drive formations 126′ configured to meshingly engage with the drive formations 108′ on the main shaft 97′. Only significant differences between the two embodiments are reflected in the Figures and the description below.

In more detail, the modified PTU 12′ shown in FIG. 15 operates substantially the same as the prior PTU 12 wherein the range shift collar 84′ transfers power from the input shaft 16′, through the planetary gear set 58′, to the front differential 22′, and to the right and left output shafts 50′, 52′. The planetary gear set 58′ includes planet gears 64′ rotatably supported by the planetary carrier 66′ and meshed radially with the sun gear 60′ and the planetary ring gear 62′. The PTU 12′ also includes the PTU gear set 18′ having the main ring gear 110′ supported on the main shaft 97′ and includes the hypoid pinion gear 112 and pinion shaft 114 shown in FIG. 1.

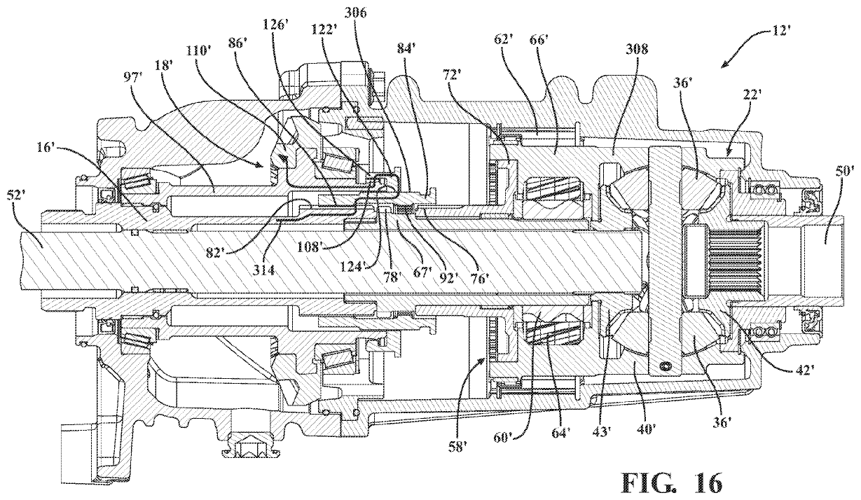

The range shift collar 84′ is axially repositionable along the input drive teeth 82′ on the input shaft 16′ between a high position (FIG. 15) corresponding to a high range mode, a neutral position (neutral mode, FIG. 16) disengaged from the front differential 22′, and a low position (FIG. 17) corresponding to a low range mode while maintaining the inner drive formations 86′ meshingly engaged with the input drive teeth 82′ on the input shaft 16′.

Referring to FIG. 15, the input drive teeth 82′ on the input shaft 16′ are formed on an outer circumference or surface of the input shaft 16′. The carrier drive teeth 76′ and the sun drive teeth 78′ are formed on an outer circumference or surface of the inboard carrier section 72′ and the sun shaft 67′, respectively, face radially outwardly, and are axially spaced apart. The inner drive formations 86′ and the lower drive formations 92′ are formed on an inner circumference or surface of the range shift collar 84′, are axially spaced apart, and face radially inwardly. However, it will be appreciated that the input drive teeth 82′, the carrier drive teeth 76′, the sun drive teeth 78′, the inner drive formations 86′, and the lower drive formations 92′ might be formed with alternate configurations, such as facing radially outwardly, facing radially inwardly, and/or facing in an axial direction without varying the scope of the present invention.

Generally, the drive teeth 76′, 78′, 82′ and the drive formations 86′, 92′ are located at or about the same radial distance from the central axis extending through the input shaft 16′, the left output shaft 52′, and the right output shaft 50′ although the distances may vary to vary torque transmission characteristics. Further, the upper drive formations 306 on the range shift collar 84′ and the input drive formations 124′ on the takeoff shift collar 122′ are located radially offset from the other drive teeth 76′, 78′, 82′ and the other drive formations 86′, 92′. In addition, the drive formations 108′ on the main shaft 97′ and the output drive formations 126′ on the takeoff shift collar 122′ are located radially offset from other drive teeth 76′, 78′, 82′ and the other drive formations 86′, 92′, 124′, 306. However, it will be appreciated that the radial position of the drive teeth 76′, 78′, 82′ and the drive formations 86′, 92′, 108, 124′, 126′, 306 might vary without altering the scope of the present invention.

When the range shift collar 84′ is in the high position shown in FIG. 15, power is transferred from the input shaft 16′ through the input drive teeth 82′ meshingly engaged with the inner drive formations 86′ to the range shift collar 84′. Next, the range shift collar 84′ transfers power through the drive formations 92′ meshingly engaged with the carrier drive teeth 76′ on the inboard carrier section 72′ and through the planetary carrier 66′. The planetary carrier 66′ transfers high gear range power to the differential housing 40′, through the differential pinion gears 36′, the side gears 42′, 43′, and to the output shafts 50′, 52′, as illustrated by arrow 308.

When the range shift collar 84′ is in the neutral position shown in FIG. 16, the lower drive formations 92′ are spaced axially apart from both the carrier drive teeth 76′ and the sun drive teeth 78′. As such, power from the input shaft 16′ is transferred to the range shift collar 84′ but is prevented from being transferred to the front differential 22′.

When the range shift collar 84′ is in the low position shown in FIG. 17, power is transferred from the input shaft 16′ through the input drive teeth 82′ meshingly engaged with the inner drive formations 86′ to the range shift collar 84′. Next, the range shift collar 84′ transfers power through the drive formations 92′ meshingly engaged with the sun drive teeth 78′ on the sun shaft 67′ and through the sun gear 60′, the planet gears 64′, and to the planetary carrier 66′. The planetary carrier 66′ transfers low gear range power to the differential housing 40′, through the differential pinion gears 36′, the side gears 42′, 43′, and to the output shafts 50′, 52′, as illustrated by arrow 310.

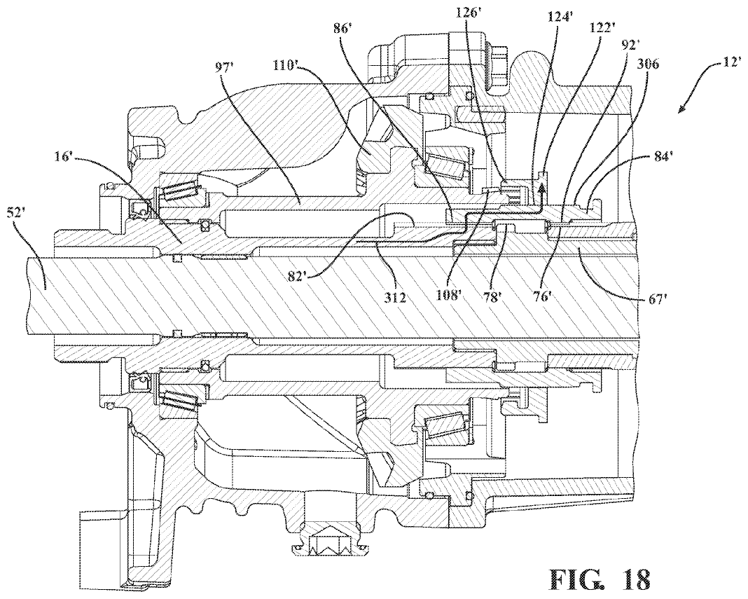

The takeoff shift collar 122′ is axially repositionable along the upper drive formations 306 on the range shift collar 84′ between a disengaged position (FIG. 18) corresponding to the disengaged mode and an engaged position (FIG. 16) corresponding to the engaged mode while maintaining the takeoff input drive formations 124′ meshingly engaged with the upper drive formations 306 on the range shift collar 84′. The takeoff shift collar 122′ is in the disengaged position in FIG. 18 with the output drive formations 126′ spaced axially apart from the drive formations 108′ on the main shaft 97′. While power is transferred from the input shaft 16′ to the range shift collar 84′ and into the takeoff shift collar 122′ (arrow 312), power is not transferred from the takeoff shift collar 122′ to the main ring gear 110′. As such, power is also not transferred through the PTU gear set 18′ and the RDM 14 will not receive power from the prop shaft 26.

The takeoff shift collar 122′ is in the engaged position in FIG. 16 with the output drive formations 126′ meshingly engaged with the drive formations 108′ on the main shaft 97′. When the takeoff shift collar 122′ is in the engaged position, power is transferred from the input shaft 16′, through the input drive teeth 82′ meshingly engaged with the inner drive formations 86′ on the range shift collar 84′, through the upper drive formations 306 meshingly engaged with the input drive formations 124′ on the takeoff shift collar 122′, through the output drive formations 126′ meshingly engaged with the drive formations 108′ on the main shaft 97′, and to the main ring gear 110′, as illustrated by arrow 314. Power is transferred from the main ring gear 110′ through the PTU gear set 18′, to the prop shaft 26, and supplied to the RDM 14 as in the first embodiment. The takeoff shift collar 122′ is able to receive power supplied by the range shift collar 84′ from the input shaft 16′ when the range shift collar 84′ is in the high position, the neutral position, and in the low position. In addition, the takeoff shift collar 122′ transfers the power received from the range shift collar 84′ to the PTU gear set 18′ when the takeoff shift collar 122′ is in the engaged position.

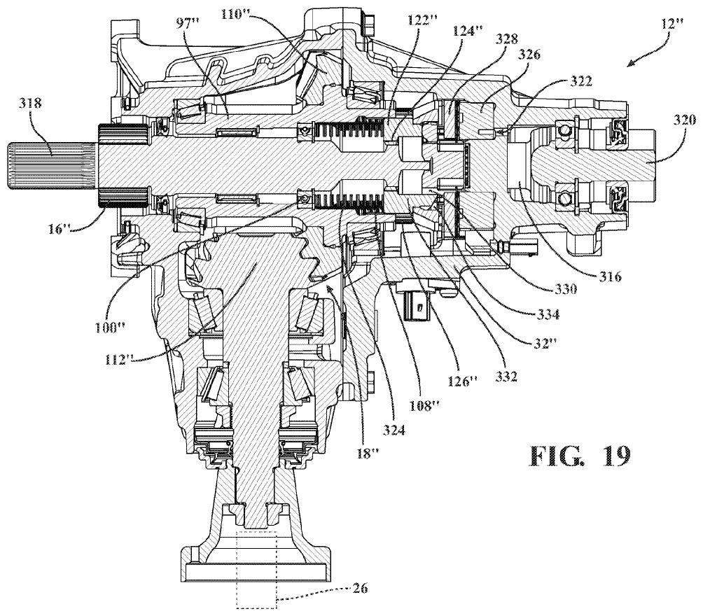

A third embodiment of the PTU 12″ is shown in FIGS. 19-21, which uses like double primed reference numerals representing similar elements as those described above. Referring to FIG. 19, this modified PTU 12″ lacks the range shift collar 84, 84′, the planetary gear set 58, 58′, the front differential 22, 22′, the actuator assembly 28, and the output shafts 50, 50′, 52, 52′ of the prior PTU embodiments 12, 12′ described above. Instead, this modified PTU 12″ is a single speed PTU 12″ and includes a link shaft 316 having left and right ends 318, 320 for driving the wheels. In addition, the PTU 12″ includes the input shaft 16″ splined to the link shaft 316 for providing power to the link shaft 316. The PTU 12″ also includes the PTU gear set 18″ for transferring power from the input shaft 16″ to the prop shaft 26 and to the RDM 14, as in the prior embodiments. The PTU 12″ also includes the takeoff shift collar 122″ for transferring power from the input shaft 16″ to the main shaft 97″ and through the PTU gear set 18″. The axial position of the takeoff shift collar 122″ is controlled by a cam actuator 322 and a return spring 324 instead of the actuator assembly 28 described above. Only significant differences between the two embodiments are reflected in the Figures and the description below.

Referring to FIG. 19, the main shaft 97″ includes mainshaft drive formations 108″ on an inner circumference or surface and face radially inwardly. The main shaft 97″ transfers received power to the main ring gear 110″ which transfers the power to the hypoid pinion gear 112″, as previously illustrated by arrow 138 in FIG. 1. In addition, the input shaft 16″ includes input drive teeth 82″ formed on an outer circumference or surface of the end flange 80″ and face radially outwardly. However, it will be appreciated that the mainshaft drive formations 108″ and the input drive teeth 82″ might be formed with alternate configurations, such as facing radially outwardly, radially inwardly, or in an axial direction without varying the scope of the present invention.

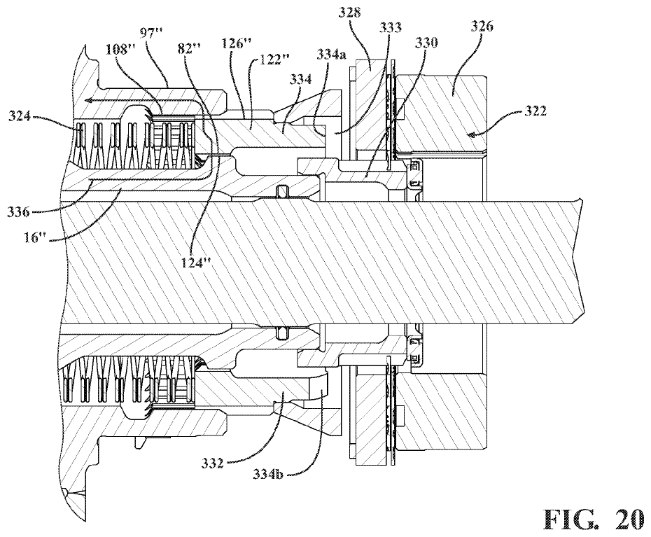

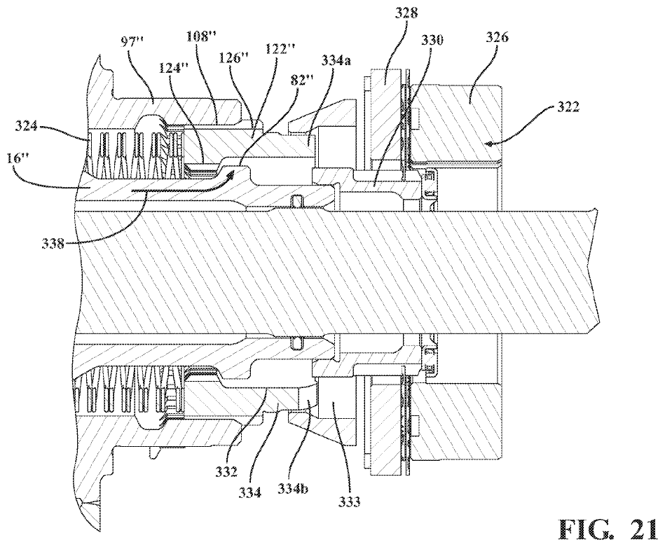

Referring to FIGS. 19-21, the takeoff shift collar 122″ includes output drive formations 126″ formed on an outer circumference or surface and face radially outwardly. However, it will be appreciated that the output drive formations 126″ might be formed with alternate configurations, such as facing radially outwardly, radially inwardly, or in an axial direction without varying the scope of the present invention. The output drive formations 126″ are meshingly engaged with the mainshaft drive formations 108″ on the main shaft 97″ while allowing the takeoff shift collar 122″ to be displaceable axially along the mainshaft drive formations 108″ so as to remain engaged therewith in both the engaged position (FIG. 20) and the disengaged position (FIG. 21), corresponding to the engaged mode and the disengaged mode, respectively. In addition, the takeoff shift collar 122″ includes input drive formations 124″ formed on an inner circumference or surface and face radially inwardly. The input drive formations 124″ are meshingly engaged with the input drive teeth 82″ on the input shaft 16″ when the takeoff shift collar 122″ is in the engaged position shown in FIGS. 19 and 20. As shown in FIG. 21, the input drive formations 124″ are axially spaced apart from the input drive teeth 82″ on the input shaft 16″ when the takeoff shift collar 122″ is in the disengaged position. However, it will be appreciated that the input drive formations 124″ might be formed with alternate configurations, such as facing radially outwardly, radially inwardly, or in an axial direction without varying the scope of the present invention.

Referring to FIGS. 19-21, the cam actuator 322 is configured to reposition the takeoff shift collar 122″ between the engaged position (FIG. 20) and the disengaged position (FIG. 21). The cam actuator 322 is a self-energizing compact disconnect actuator used to connect and disconnect the takeoff shift collar 122″ from the input shaft 16″ and is similar to other known cam actuators. The cam actuator 322 includes an electromagnetic coil 326, a pilot clutch 328, a clutch cam 330, and a shift cam 332. The electromagnetic coil 326 is selectively energized to engage and disengage the takeoff shift collar 122″ and the input shaft 16″. The pilot clutch 328 may comprise one or more inner plates and outer plates and may be housed within an armature. The inner plates of the pilot clutch 328 are splined to the clutch cam 330. The outer plates of pilot clutch 328 are splined to stationary housing 32″. A clutch cam profile 333 on the clutch cam 330 contacts a cam profile 334 on the face of the shift cam 332. The shift cam 332 is supported by the takeoff shift collar 122″, either integrally formed therewith or as a separate component, such that rotation of the shift cam 332 rotates the takeoff shift collar 122″ and the takeoff shift collar 122″ is repositioned axially with the shift cam 332. The shift cam 332 is operatively connected to the main shaft 97″ through the takeoff shift collar 122″ and rotates with main shaft 97″ but is configured to move axially relative to the main shaft 97″. The cam profile 334 on the shift cam 332 possesses a bi-stable profile which includes both an engaged portion 334a and a disengaged portion 334b, corresponding to the engaged position and the disengaged position, respectively, of the takeoff shift collar 122″. The cam actuator 322 also includes the return spring 324 which is radially supported by the main shaft 97″ and axially supported between the takeoff shift collar 122″ and the bearing 100″ supporting the input shaft 16″. The return spring 324 spring-biases the takeoff shift collar 122″ towards the engaged condition with the input shaft 16″ and spring-biases the shift cam 332 into an engaged condition with the clutch cam 330.

In operation, when the clutch cam profile 333 is engaged with one of the engaged and disengaged cam portions 334a, 334b, actuating the cam actuator 322 causes the clutch cam 330 to stop rotating or slow the rotation rate relative to the shift cam 332. The change in the rotation rate of the clutch cam 330 relative to the rotation rate of the shift cam 332 causes the clutch cam 330 to engage with the other one of the engaged and disengaged cam portions 334a, 334b, causing the shift cam 332 to convert rotary motion of shift cam 332 into axial (linear) motion of the shift cam 332, and causing the takeoff shift collar 122″ to be repositioned between the engaged position and the disengaged position. When the takeoff shift collar 122″ is in the engaged position shown in FIG. 20, power is transferred from the input shaft 16″, through the input drive teeth 82″ meshingly engaged with the input drive formations 124″ on the takeoff shift collar 122″, and through the output drive formations 126″ meshingly engaged with the drive formations 108″ on the main shaft 97″, as illustrated by arrow 336. Next, power transferred to the main shaft 97″ is transferred through the PTU gear set 18″ to the prop shaft 26, as previously illustrated by arrow 138 in FIG. 1. When the takeoff shift collar 122″ is in the disengaged position shown in FIG. 21, power is not transferred to the takeoff shift collar 122″ since the input drive formations 124″ are spaced axially apart from the input drive teeth 82″ on the input shaft 16″, as illustrated by arrow 338.

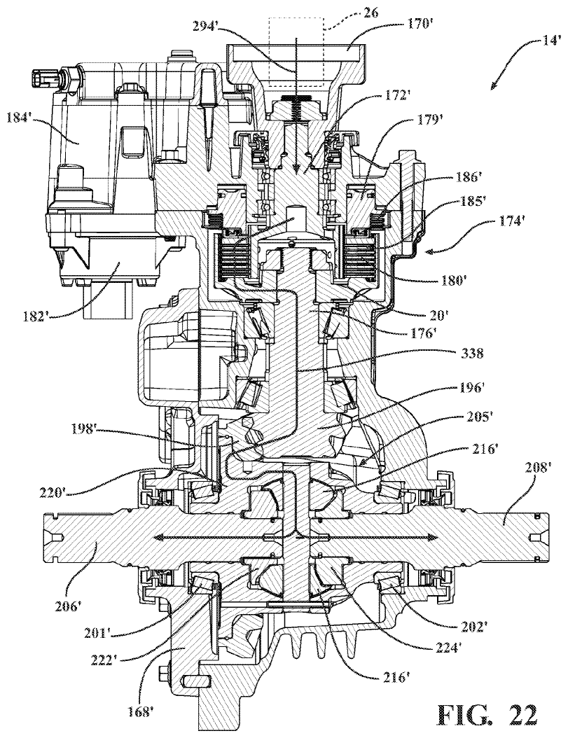

A second embodiment of the RDM 14′ is shown in FIG. 22, which uses like primed reference numerals representing similar elements as those described above. Referring to FIG. 22, this modified RDM 14′ lacks the shift collar 262, the actuator assembly 264, and the planetary gear set 204 of the RDM 14 shown in FIG. 2. As such, the RDM 14′ is a single speed RDM 14′ instead of the two-speed RDM 14 of FIG. 2. Only significant differences between the two embodiments are reflected in the Figures and the description below.

Referring to FIG. 22, the differential housing 220′ of the rear differential 205′ is radially and axially supported by axially spaced apart bearings 201′, 202′, which in turn are supported by the stationary housing 168′. In addition, the differential housing 220′ is rotatably supported on an outer circumference of the left and right output shafts 206′, 208′. The main ring gear 198′ is supported by the differential housing 220′ such that rotation of the main ring gear 198′ causes the differential housing 220′ to rotate. The main ring gear 198′ and the differential housing 220′ are in a stacked arrangement between the bearings 201′, 202′. It will be appreciated that the bearings 201′ and 202′ might be tapered roller bearings or might be other known types of bearings.

The RDM 14′ includes the prop shaft flange 170′ configured to be fixedly coupled to the prop shaft 26, the input hub 172′, and the torque transfer coupling 174′. Power received from the prop shaft 26 by the prop shaft flange 170′ is transferred to the input hub 172′, as illustrated by arrow 294′. When the torque transfer coupling 174′ is deactivated, the return spring 186′ biases the hydraulic piston 179′ away from the friction clutch 180′ causing the friction plates 185′ within the friction clutch 180′ to disengage which prevents power being transferred from the input hub 172′ to the clutch drum 20′. When the friction clutch 180′ is disengaged, power is also prevented from traveling from the clutch drum 20′ to the prop shaft 26. When hydraulic pressure is removed from the hydraulic piston 179′, the return spring 186′ creates additional separation between the friction plates 185′ within the friction clutch 180′ in order to reduce the residual drag torque across the friction clutch 180′ which allows the AWD system 10 drag torque to become low enough to stop rotation of the driveline components.

In order to engage the RMD 14′ and transfer power to the left and right output shafts 206′, 208′, the hydraulic motor 182′ is activated which causes the hydraulic pump 184′ to apply hydraulic pressure to the hydraulic piston 179′ and causes the friction clutch 180′ to engage. After the friction clutch 180′ engages, power is transferred from the input hub 172′, through the friction clutch 180′, and to the hypoid pinion shaft 176′. Next, power is transferred from the hypoid pinion shaft 176′, through the hypoid pinion gear 196′ to the main ring gear 198′, and into the differential housing 220′ of the rear differential 205′. The differential housing 220′ transfers the power through the differential pinion gears 216′, the side gears 222′, 224′, and to the left and right output shafts 206′, 208′, as illustrated by arrow 338.

As discussed above, the all-wheel drive (AWD) system 10 includes a power takeoff unit (PTU) 12, 12′, 12″ configured to selectively provide power through a prop shaft 26 to a rear drive module (RDM) 14′, 14″ for driving rear wheels of the vehicle. The AWD system 10 is configured to selectively decouple the PTU 12, 12′, 12″ and the RDM 14, 14′ and stop rotation of certain components within the AWD system 10. In more detail, the PTU 12, 12′, 12″ includes a takeoff shift collar 122, 122′, 122″ configured to selectively disconnect an input shaft 16, 16′, 16″ from a main shaft 97, 97′, 97″ to prevent power being transferred from the input shaft 16, 16′, 16″ to the RDM 14, 14′. In addition, the PTU 12, 12′ includes an optional planetary gear set 58, 58′ for providing high range power and low range power to a front differential 22, 22′ and a range shift collar 84, 84′ for selectively providing high range power or low range power to the front differential 22, 22′. Further, the PTU 12, 12′ includes a single actuator for axially repositioning the takeoff shift collar 122, 122′, 122″ and the range shift collar 84, 84′ to selectively transfer power to the RDM 14, 14′ and to selectively shift into an optional low range gear. Further, the RDM 14, 14′ includes a torque transfer coupling 174, 174′ configured to selectively decouple an input hub 172, 172′ from a clutch drum 20, 20′ to prevent power from being transferred between the clutch drum 20, 20′ and the prop shaft 26. In addition, the RDM 14 includes shift collar 262, a planetary gear set 204, and a rear differential 205 wherein the shift collar 262 is axially repositionable to provide 4HI power or 4LO power to the rear differential 205. The shift collar 262 is optionally repositionable to a 4LO-Lock position providing 4LO power to the rear differential 205 and locking one of the output shafts 206 to a differential shaft 233.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A power takeoff unit for a vehicle comprising:
an input shaft configured to receive power provided to the power takeoff unit;
a main shaft;
a main ring gear non-rotatably coupled to the main shaft and which rotates in response to rotation of the main shaft;
a hypoid pinion gear meshingly engaged with the main ring gear and a pinion shaft non-rotatably coupled to the hypoid pinion gear such that rotation of the main ring gear causes the hypoid pinion gear and the pinion shaft to rotate; and
a takeoff shift collar which is axially slidable between an engaged position operatively coupling the input shaft to the main shaft and a disengaged position which disconnects the input shaft from the main shaft;
wherein power received by the input shaft is transferred through the takeoff shift collar to the main shaft, through the main ring gear, the hypoid pinion gear, and to the pinion shaft when the takeoff shift collar is in the engaged position and wherein the main shaft is decoupled from the input shaft when the takeoff shift collar is in the disengaged position.

2. The power takeoff unit according to claim 1, wherein:
the main shaft includes mainshaft drive formations;
the input shaft includes input drive teeth;
the takeoff shift collar includes output drive formations configured to meshingly engage with the mainshaft drive formations when the takeoff shift collar is in the engaged position and includes input drive formations configured to meshingly engage with the input drive teeth when the takeoff shift collar is in the engaged position;
one of the input drive formations and the output drive formations are decoupled from the input drive teeth or the mainshaft drive formations, respectively, when the takeoff shift collar is in the disengaged position; and
an other one of the input drive formations and the output drive formations maintain engagement with the input drive teeth or the mainshaft drive formations, respectively, when the takeoff shift collar is repositioned axially between the disengaged position and the engaged position.

3. The power takeoff unit according to claim 2, further comprising:
a cam actuator configured to selectively reposition the takeoff shift collar axially between the engaged position and the disengaged position.

4. The power takeoff unit according to claim 1, further comprising:
a differential comprising: a differential housing, opposing pinion gears rotatably connected together by a pinion shaft which is mechanically connected to the differential housing, opposing first and second side gears in meshing engagement with the pinion gears such that power can be transferred from the differential housing to the pinion gears and then to the first and second side gears;
a first output shaft non-rotatably coupled to the first side gear;
a second output shaft non-rotatably coupled to the second side gear;
a planetary gear set comprising a sun gear non-rotatably coupled to a sun shaft, a planetary ring gear disposed radially outwardly of the sun gear, and a planetary carrier assembly comprising a planetary carrier rotatably supporting one or more planet gears thereon, wherein the planetary carrier is engaged with the planet gears for rotation together and the planet gears rotate between the sun gear and the planetary ring gear during rotation of the planetary carrier, and the planetary carrier is non-rotatably coupled to the differential housing such that rotation of the planetary carrier causes the differential housing to rotate; and
a range shift collar rotationally and slidably coupled to the input shaft such that the range shift collar rotates with the input shaft and is axially slidable relative thereto, the range shift collar is axially slidable between a high position connecting the range shift collar to the planetary carrier for transferring power received from the input shaft to the planetary carrier and a low position connecting range shift collar to the sun shaft for transferring power received from the input shaft to the sun gear.

5. The power takeoff unit according to claim 4, further comprising:
an actuator assembly configured to reposition the takeoff shift collar between the engaged position and the disengaged position and configured to reposition the range shift collar between the high position and the low position.

6. The power takeoff unit according to claim 5, wherein the actuator assembly is a barrel cam actuator comprising:
a barrel cam having a longitudinal axis and having a takeoff cam slot and a range cam slot extending in a circumferential direction around the barrel cam, the barrel cam rotatable about the longitudinal axis;
a takeoff shift fork fixedly coupled to the takeoff shift collar and operatively coupled to the takeoff cam slot;
a range shift fork fixedly coupled to the range shift collar and operatively coupled to the range cam slot; and
a barrel cam motor operatively coupled to the barrel cam and configured to selectively rotate the barrel cam about the longitudinal axis causing the takeoff shift fork to reposition the takeoff shift collar axially between the engaged position and the disengaged position and causing the range shift fork to reposition the range shift collar axially between the high position and the low position.

7. The power takeoff unit according to claim 6, wherein:
the input shaft includes input drive teeth;
the sun shaft includes sun drive teeth for rotatably driving the sun gear;
the planetary carrier includes carrier drive teeth for rotatably driving the planetary carrier;
the range shift collar includes input drive formations meshingly engaged with the input drive teeth on the input shaft and axially slidable relative thereto between the high position and the low position and includes inner drive formations spaced apart from the input drive formations;
when the range shift collar is in the low position, the inner drive formations are meshingly engaged with the sun drive teeth for transferring power received from the input shaft to through the sun gear for providing low gear range power to the differential housing; and
when the range shift collar is in the high position, the inner drive formations meshingly engaged with the carrier drive teeth for transferring power received from the input shaft through the planetary carrier for providing high gear range power to the differential housing.

8. The power takeoff unit according to claim 6, wherein:
the input shaft includes input drive teeth;
the sun shaft includes sun drive teeth for rotatably driving the sun gear;
the planetary carrier includes carrier drive teeth for rotatably driving the planetary carrier;
the range shift collar includes input drive formations meshingly engaged with the input drive teeth on the input shaft and axially slidable relative thereto between the high position and the low position, inner drive formations spaced apart from the input drive formations, and high drive formations spaced radially apart from the inner drive formations and the input drive formations;
when the range shift collar is in the high position, the high drive formations are meshingly engaged with the carrier drive teeth on the planetary carrier for transferring power received from the input shaft to the planetary carrier and the inner drive formations are spaced axially apart from the sun drive teeth; and
when the range shift collar is in the low position, the inner drive formations are meshingly engaged with the sun drive teeth for transferring power received from the input shaft through the sun gear for providing power to the differential housing and the high drive formations are spaced axially apart from the carrier drive teeth.

9. The power takeoff unit according to claim 6, wherein:
the input shaft includes input drive teeth;
the main shaft including mainshaft drive formations;
the takeoff shift collar includes output drive formations configured to meshingly engage with the mainshaft drive formations when the takeoff shift collar is in the engaged position;
the takeoff shift collar includes input drive formations meshingly engaged with the input drive teeth on the input shaft and axially slidable relative thereto between the engaged position with the output drive formations in meshing engagement with the mainshaft drive formations for transferring power received from the input shaft through the takeoff shift collar to the main shaft and the disengaged position wherein the output drive formations are axially spaced apart from the mainshaft drive formations on the main shaft which prevents power from being transferred from the input shaft to the main shaft.

10. The power takeoff unit according to claim 6, wherein:
the range shift collar includes upper drive formations;
the main shaft including mainshaft drive formations;
the takeoff shift collar includes input drive formations configured to meshingly engage with the upper drive formations on the range shift collar while being axially slidable relative thereto between the engaged position and the disengaged position; and
the takeoff shift collar includes output drive formations configured to meshingly engage with the mainshaft drive formations when the takeoff shift collar is in the engaged position, the output drive formations are axially spaced apart from the mainshaft drive formations when the takeoff shift collar is in the disengaged position, and the input drive formations maintain engagement with the upper drive formations as the takeoff shift collar is repositioned between the engaged position and the disengaged position.

11. A rear drive module for a vehicle comprising:
an input hub configured to receive power;
a clutch drum;
a torque transfer coupling configured to selectively transfer power between the input hub and the clutch drum when the torque transfer coupling is in an engaged condition, wherein the input hub is decoupled from the clutch drum when the torque transfer coupling is in a disengaged condition;
a hypoid pinion shaft non-rotatably coupled to the clutch drum;
a hypoid pinion gear non-rotatably coupled to the hypoid pinion shaft wherein the hypoid pinion gear and the clutch drum rotate together;
a main ring gear meshingly engaged with the hypoid pinion gear;
a differential comprising: a differential housing, a differential shaft non-rotatably coupled to the differential housing, opposing pinion gears rotatably connected together by a pinion shaft which is mechanically connected to the differential housing, opposing first and second side gears in meshing engagement with the pinion gears such that power can be transferred from the differential housing to the pinion gears and then to the first and second side gears;
a first output shaft non-rotatably coupled to the first side gear;
a second output shaft non-rotatably coupled to the second side gear;
a planetary gear set comprising a sun gear non-rotatably coupled to a sun shaft which is non-rotatably coupled to the main ring gear, a planetary ring gear disposed radially outwardly of the sun gear, and a planetary carrier assembly comprising a planetary carrier rotatably supporting one or more planet gears thereon, wherein the planetary carrier is engaged with the planet gears for rotation together and the planet gears rotate between the sun gear and the planetary ring gear during rotation of the planetary carrier; and
a shift collar splined to the differential shaft such that the shift collar rotates with the differential shaft while being axially slidable relative thereto, the shift collar is axially slidable between a 4HI position connecting the sun shaft to the differential shaft for transferring power received from the hypoid pinion gear to the differential housing and a 4LO position connecting the planetary carrier to the differential shaft for transferring power received from the planetary carrier to the differential housing, wherein the 4HI position is axially spaced apart from the 4LO position.

12. The rear drive module according to claim 11, wherein:
the differential shaft includes differential drive teeth; and
the shift collar includes output drive formations meshingly engaged with the differential drive teeth and which are axially slidable relative thereto between the 4HI position and the 4LO position.

13. The rear drive module according to claim 12, wherein:
the sun shaft includes sun drive teeth;
the shift collar includes lower drive formations configured to meshingly engage with the sun drive teeth when the shift collar is in the 4HI position; and
the lower drive formations are spaced axially apart from the sun drive teeth when the shift collar is spaced apart from the 4HI position.

14. The rear drive module according to claim 13, wherein:
the planetary carrier includes carrier drive teeth;
the shift collar includes upper drive formations configured to meshingly engage with the carrier drive teeth when the shift collar is in the 4LO position; and
the upper drive formations are spaced axially apart from the carrier drive teeth when the shift collar is in the 4HI position.

15. The rear drive module according to claim 14, wherein:
the shift collar is axially slidable between a 4LO-Lock position and the 4LO position while maintaining the output drive formations in meshing engagement with the differential drive teeth, the 4LO-Lock position axially spaced apart from the 4LO position,
the first output shaft includes locking drive teeth;
when the shift collar is in the 4LO-Lock position, the output drive formations are meshingly engaged with the locking drive teeth and with the differential drive teeth; and
when the shift collar is in the 4LO position, the output drive formations are spaced axially apart from the locking drive teeth and meshingly engaged with the differential drive teeth.

16. The rear drive module according to claim 15, further comprising:
an actuator assembly configured to axially reposition the shift collar between the 4LO-Lock position, the 4LO position, and the 4HI position.

17. The rear drive module according to claim 16, wherein the actuator assembly is a barrel cam actuator comprising:
a barrel cam having a longitudinal axis and having a cam slot extending in a circumferential direction around the barrel cam, the barrel cam rotatable about the longitudinal axis;
a shift fork fixedly coupled to the shift collar and operatively coupled to the cam slot; and
a barrel cam motor operatively coupled to the barrel cam and configured to selectively rotate the barrel cam about the longitudinal axis causing the shift fork to axially reposition the shift collar axially between the shift collar between the 4LO-Lock position, the 4LO position, and the 4HI position.

18. The rear drive module according to claim 11, the torque transfer coupling further comprising a friction clutch configured to operatively couple the clutch drum to the input hub when the friction clutch is engaged and the torque transfer coupling is in the engaged condition, wherein the friction clutch decouples the clutch drum from the input hub when the friction clutch is disengaged and the torque transfer coupling is in the disengaged condition.

19. The rear drive module according to claim 18, wherein:
the friction clutch further comprises a plurality of friction plates which are repositionable in an axial direction between the engaged condition coupling the clutch drum to the input hub and the disengaged condition decoupling the clutch drum from the input hub;
the torque transfer coupling further comprises a hydraulic piston configured to selectively apply pressure to the friction plates in the axial direction to reposition the friction plates to the engaged condition and a return spring configured to bias the friction plates towards the disengaged condition; and
the return spring disengages the friction clutch decoupling the clutch drum from the input hub when pressure is removed from the friction plates.

20. The rear drive module according to claim 11, wherein the main ring gear and the differential are radially and axially supported between spaced apart bearings in a stacked arrangement.

21. A rear drive module for a vehicle comprising:
an input hub configured to receive power;
a clutch drum;
a torque transfer coupling configured to selectively transfer power between the input hub and the clutch drum when the torque transfer coupling is in an engaged condition, wherein the input hub is decoupled from the clutch drum when the torque transfer coupling is in a disengaged condition;
a hypoid pinion shaft non-rotatably coupled to the clutch drum;
a hypoid pinion gear non-rotatably coupled to the hypoid pinion shaft wherein the hypoid pinion gear and the clutch drum rotate together;
a main ring gear meshingly engaged with the hypoid pinion gear;
a differential comprising: a differential housing configured to rotate in response to rotation of the main ring gear, a differential shaft non-rotatably coupled to the differential housing, opposing pinion gears rotatably connected together by a pinion shaft which is mechanically connected to the differential housing, opposing first and second side gears in meshing engagement with the pinion gears such that power can be transferred from the differential housing to the pinion gears and then to the first and second side gears;
a first output shaft non-rotatably coupled to the first side gear; and
a second output shaft non-rotatably coupled to the second side gear;
wherein the torque transfer coupling further comprises a friction clutch including a plurality of friction plates which are repositionable in an axial direction between the engaged condition coupling the clutch drum to the input hub and the disengaged condition decoupling the clutch drum from the input hub, a hydraulic piston configured to selectively apply pressure to the friction plates in the axial direction to reposition the friction plates to the engaged condition, and a return spring configured to bias the friction plates towards the disengaged condition; and
wherein the return spring disengages the friction clutch decoupling the clutch drum from the input hub by axially separating the friction plates when pressure is removed from the friction plates.

22. The rear drive module according to claim 21, wherein the main ring gear and the differential are radially and axially supported in a stacked arrangement between spaced apart bearings.

23. An all-wheel drive system for a vehicle comprising:
the power takeoff unit according to claim 1 for selectively transferring power to pinion shaft;
a prop shaft having a first end operatively coupled to the pinion shaft such that the prop shaft rotates in response to rotation of the pinion shaft; and
a rear drive module comprising: an input hub non-rotatably coupled to the prop shaft and configured to receive power from the power takeoff unit, a clutch drum, a torque transfer coupling configured to selectively transfer power between the input hub and the clutch drum, a second hypoid pinion shaft non-rotatably coupled to the clutch drum, a second hypoid pinion gear non-rotatably coupled to the second hypoid pinion shaft, a second main ring gear meshingly engaged with the second hypoid pinion gear, a second differential comprising: a second differential housing, a second differential shaft non-rotatably coupled to the second differential housing, opposing second pinion gears rotatably connected together by a second pinion shaft which is mechanically connected to the second differential housing, opposing third and fourth side gears in meshing engagement with the second pinion gears such that power can be transferred from the second differential housing to the second pinion gears and then to the third and fourth side gears, a third output shaft non-rotatably coupled to the third side gear, a fourth output shaft non-rotatably coupled to the fourth side gear with the third side gear and the fourth side gear arranged coaxially and rotatable relative to the second differential housing, a second planetary gear set comprising a second sun gear non-rotatably coupled to a second sun shaft which is non-rotatably coupled to the second main ring gear, a second planetary ring gear disposed radially outwardly of the second sun gear, and a second planetary carrier assembly comprising a second planetary carrier rotatably supporting one or more second planet gears thereon, wherein the second planetary carrier is engaged with the second planet gears for rotation together and the second planet gears rotate between the second sun gear and the second planetary ring gear during rotation of the second planetary carrier, and a second shift collar splined to the second differential shaft such that the second shift collar rotates with the second differential shaft while being axially slidable relative thereto, wherein the second shift collar is axially slidable between a 4HI position connecting the second sun shaft to the second differential shaft for transferring power received from the second hypoid pinion gear to the second differential housing and a 4LO position connecting the second planetary carrier to the second differential shaft for transferring power received from the second planetary carrier to the second differential housing, wherein the 4HI position is axially spaced apart from the 4LO position.

24. The all-wheel drive system according to claim 23, wherein:
the second differential shaft includes differential drive teeth; and
the second shift collar includes output drive formations meshingly engaged with the differential drive teeth and which are axially slidable relative thereto between the 4HI position and the 4LO position.

25. The all-wheel drive system according to claim 24, wherein:
the second sun shaft includes sun drive teeth;
the second shift collar includes lower drive formations configured to meshingly engage with the sun drive teeth when the second shift collar is in the 4HI position; and
the lower drive formations are spaced axially apart from the sun drive teeth when the second shift collar is spaced apart from the 4HI position.

26. The all-wheel drive system according to claim 25, wherein:
the second planetary carrier includes carrier drive teeth;
the second shift collar includes upper drive formations configured to meshingly engage with the carrier drive teeth when the second shift collar is in the 4LO position; and
the upper drive formations are spaced axially apart from the carrier drive teeth when the second shift collar is in the 4HI position.

27. The all-wheel drive system according to claim 26, wherein:
the second shift collar is axially slidable between a 4LO-Lock position and the 4LO position while maintaining the output drive formations in meshing engagement with the differential drive teeth, the 4LO-Lock position axially spaced apart from the 4LO position,
the third output shaft includes locking drive teeth;
when the second shift collar is in the 4LO-Lock position, the output drive formations are meshingly engaged with the locking drive teeth and with the differential drive teeth; and
when the second shift collar is in the 4LO position, the output drive formations are spaced axially apart from the locking drive teeth and meshingly engaged with the differential drive teeth.

28. The all-wheel drive system according to claim 23, the power takeoff unit further comprising:
the main shaft including mainshaft drive formations;
the input shaft includes input drive teeth; and
the takeoff shift collar includes output drive formations configured to meshingly engage with the mainshaft drive formations and input drive formations configured to meshingly engage with the input drive teeth when the takeoff shift collar is in the engaged position;
wherein one of the input drive formations or the output drive formations are decoupled from the input drive teeth or the mainshaft drive formations, respectively, when the takeoff shift collar is in the disengaged position; and
wherein an other one of the input drive formations or the output drive formations maintain engagement with the input drive teeth or the mainshaft drive formations, respectively, when the takeoff shift collar is repositioned between the disengaged position and the engaged position.

29. The power takeoff unit according to claim 23, the power takeoff unit further comprising:
a differential comprising: a differential housing, opposing pinion gears rotatably connected together by a pinion shaft which is mechanically connected to the differential housing, opposing first and second side gears in meshing engagement with the pinion gears such that power can be transferred from the differential housing to the pinion gears and then to the first and second side gears;
a first output shaft non-rotatably coupled to the first side gear;
a second output shaft non-rotatably coupled to the second side gear;
a planetary gear set comprising a sun gear non-rotatably coupled to a sun shaft, a planetary ring gear disposed radially outwardly of the sun gear, and a planetary carrier assembly comprising a planetary carrier rotatably supporting one or more planet gears thereon, wherein the planetary carrier is engaged with the planet gears for rotation together and the planet gears rotate between the sun gear and the planetary ring gear during rotation of the planetary carrier, and the planetary carrier is non-rotatably coupled to the differential housing such that rotation of the planetary carrier causes the differential housing to rotate; and
a range shift collar rotationally and slidably coupled to the input shaft such that the range shift collar rotates with the input shaft and is axially slidable relative thereto, the range shift collar is axially slidable between a high position connecting the range shift collar to the planetary carrier for transferring power received from the input shaft to the planetary carrier and a low position connecting range shift collar to the sun shaft for transferring power received from the input shaft to the sun gear.

30. The power takeoff unit according to claim 29, further comprising:
an actuator assembly configured to reposition the takeoff shift collar between the engaged position and the disengaged position and configured to reposition the range shift collar between the high position and the low position.

31. The power takeoff unit according to claim 30, wherein the actuator assembly is a barrel cam actuator comprising:
a barrel cam having a longitudinal axis and having a takeoff cam slot and a range cam slot extending in a circumferential direction around the barrel cam, the barrel cam rotatable about the longitudinal axis;
a takeoff shift fork fixedly coupled to the takeoff shift collar and operatively coupled to the takeoff cam slot;
a range shift fork fixedly coupled to the range shift collar and operatively coupled to the range cam slot; and
a barrel cam motor operatively coupled to the barrel cam and configured to selectively rotate the barrel cam about the longitudinal axis causing the takeoff shift fork to reposition the takeoff shift collar axially between the engaged position and the disengaged position and causing the range shift fork to reposition the range shift collar axially between the high position and the low position.
